(19) United States
(12) Patent Application Publication
(10) Pub. No.: US 2018/0033009 A1
(43) Pub. Date: Feb. 1, 2018

(54) METHOD AND SYSTEM FOR FACILITATING THE IDENTIFICATION AND PREVENTION OF POTENTIALLY FRAUDULENT ACTIVITY IN A FINANCIAL SYSTEM

(71) Applicant: Intuit Inc., Mountain View, CA (US)

(72) Inventors: Jonathan R. Goldman, Mountain View, CA (US); Monica Tremont Hsu, Burlingame, CA (US); Efraim Feinstein, Palo Alto, CA (US)

(73) Assignee: Intuit Inc., Mountain View, CA (US)

(21) Appl. No.: 15/220,759

(22) Filed: Jul. 27, 2016

(51) Int. Cl. G06Q 20/40; G06Q 50/26; G06Q 40/00; H04L 29/06

(52) U.S. Cl. CPC G06Q 20/4016; H04L 63/102; G06Q 50/265; G06Q 40/10; G06Q 20/4014

(57) ABSTRACT

Account takeover and stolen identity refund fraud are types of Internet-centric crime (i.e., cybercrime) that include the unauthorized access or use of a user account or identity information to file a tax return in order to obtain a tax refund and/or tax credit from, for example, a state or federal revenue service. Because fraudsters access legitimate user accounts or use legitimate identity information to create user accounts, it can be difficult to detect fraudulent activity in user accounts. Methods and systems of the present disclosure facilitate the identification and prevention of potential fraudulent activity in a financial system, according to one embodiment. The methods and systems automate fraud claim receipt, predictive model training, risk score threshold improvement/optimization, and/or investigation of potentially affected user accounts, according to one embodiment.

### BACKGROUND

Financial systems are diverse and valuable tools, providing services that were either never before available, or were previously available only through interaction with a human professional. For example, a financial system can be configured to provide tax preparation services or other financial management services. Prior to the advent of electronic financial systems, a user would be required to consult with a tax preparation or financial management professional for services, and the user would be limited, and potentially inconvenienced, by the hours during which the professional was available for consultation. Furthermore, the user might be required to travel to the professional's physical location. Beyond the inconveniences of scheduling and travel, the user would also be at the mercy of the professional's education, skill, personality, and varying moods. All of these factors resulted in a user who was vulnerable to human error, variations in human ability, and variations in human temperament.

Some financial systems provide services that human professionals are not capable of providing, and even those financial systems that provide services that are similar to services that have historically been provided by human professionals offer many benefits, such as: not having limited working hours, not being geographically limited, and not being subject to human error or variations in human ability or temperament. Because financial systems represent a potentially flexible, highly accessible, and affordable source of services, they have the potential of attracting both positive and negative attention.

Fraudsters (cybercriminals) target financial systems to obtain money or financial credit using a variety of unethical techniques. For example, fraudsters can target tax return preparation systems to obtain tax refunds and/or tax credits based on legitimate and/or illegitimate information for legitimate users. In one example of fraudulent activity against a tax return preparation system, a gang of fraudsters could share resources to steal millions of dollars of tax refunds during a tax season. Such an experience can be traumatic for tax return preparation system users and can have a chilling effect on potential future users of a tax return preparation system. Such security risks are bad for tax filers and can damage relations between tax filers and tax return preparation service providers.

Fraudsters can use stolen identity refund fraud (“SIRF”) as one technique for stealing from people and/or from state or federal revenue services. In SIRF, fraudsters steal identities through phishing attacks (e.g., through deceitful links in email messages) or by purchasing identities using identity theft services in underground markets. Fraudsters then create user accounts in financial systems (e.g., a tax return preparation system) with the identities of actual people or businesses. The resulting user accounts may digitally appear to be legitimate because legitimate identity information was used to create the account, even though the account creator was unauthorized to do so.

Fraudsters can use account take over (“ATO”) as one technique for stealing from people. In ATO, fraudsters steal identities through phishing attacks (e.g., through deceitful links in email messages) or by purchasing identities using identity theft services in underground markets. Because fraudsters acquire user identities and/or credentials from sources that are external to and unrelated to financial systems, the financial systems are historically not able to prevent fraudsters from accessing and using other peoples' (victims′) accounts.

While service providers want to protect their customers, the fraudsters are unfortunately using legitimate identity information to hack into users' financial system accounts. If financial systems have to block legitimate login credentials, how can anyone receive the service providers' services? What's more, as cybercrime is proved repeatedly successful, if unchecked, this Internet-centric problem has the potential of only growing worse (e.g., more popular to criminals).

Potential fraudulent activity hurts users and hurts the service providers that work to make users' lives more manageable by providing financial services. What is needed is a method and system for facilitating identification and prevention of potentially fraudulent activity in a financial system, according to one embodiment.

### SUMMARY

Fraudulent activity in financial systems (e.g., tax return preparation systems) can be a costly crime. One type of fraudulent activity is stolen identity refund fraud (“SIRF”) and another type of fraudulent activity is account takeover (“ATO”). SIRF is an Internet-centric crime (i.e., cybercrime) that includes unauthorized use of business or personal identity information to file for a tax refund, without permission of the owner of the identity information. ATO is an Internet-centric crime that includes unauthorized use of credentials or identification information to access a user account (e.g., in a financial system). Cybercriminals (a.k.a., fraudsters) typically access or create user accounts in financial systems, add information to the user accounts to increase the chances of obtaining tax refunds with the user accounts, file tax returns for the user accounts, and direct the tax refunds to the fraudsters or to financial institution accounts (e.g., bank accounts) that the fraudsters can access. Because fraudsters acquire the credentials or identity information through illegal sales, phishing, spyware, and/or malware scams, fraudsters are acquiring the identity information for unsuspecting victims. Although service providers of financial systems are not contributing to the fraudulent activity, the service providers of the financial systems actively work to protect their customers' financial interests and eliminate/reduce fraudulent activity. The systems and methods of the present disclosure provide techniques for facilitating the identification and reduction of potential fraudulent activity in a financial system to protect users' accounts, even if victims have unwittingly provided the fraudsters with the victims' identity information, according to one embodiment.

The present disclosure includes methods and systems for facilitating identification and prevention of potential fraudulent activity in a financial system, according to one embodiment. To identify, address, and/or reduce the potential fraudulent activity, a security system: receives system access data for a user account, generates one or more risk scores based on the system access data, and performs one or more risk reduction actions based on the likelihood of potential fraud that is represented by the one or more risk scores, according to one embodiment.

To facilitate the identification and/or reduction of potentially fraudulent activity, the security system uses features of a claim manager, a fraud investigation module, a risk score threshold manager, and/or an authentication module, according to one embodiment. These features increase the automation of risk determination, increase the likelihood of discovering potential fraudulent activity, and improve the performance/accuracy of fraud risk analysis, according to one embodiment.

The claim manager enables users to electronically submit claims of potentially fraudulent activity to the security system, according to one embodiment. By receiving electronically submitted claims of potentially fraudulent activity, users do not have to wait for customer service to be available to submit a claim and risk reduction actions can be implemented more quickly to secure a user's account, according to one embodiment. The security system uses the claims of potentially fraudulent activity to train and/or update predictive models that are used to detect potentially fraudulent activity based on the behavior of users who access the financial system, according to one embodiment.

The fraud investigation module identifies additional user accounts that are potentially affected by fraudulent activity based on one or more user accounts that have been flagged for fraudulent activity (e.g., via the claim manager, by customer support representatives, etc.), according to one embodiment. The fraud investigation module analyzes user accounts of the financial system for similar characteristics as the flagged user account, according to one embodiment. The additional user accounts that have one or more characteristics in common with the flagged user account are sent to an investigation team and/or are analyzed by the security system to determine the likelihood of potential fraudulent activity associated with the additional user accounts, according to one embodiment. By using the fraud investigation modules, the security system proactively searches for additional user accounts that may be affected by fraudulent activity, in order to proactive reduce the likelihood of fraudulent activity in the financial system, according to one embodiment.

The risk score threshold manager analyzes the effects of risk score thresholds and adjusts the risk score thresholds to improve the performance of the risk analysis of the security system, according to one embodiment. The risk score threshold manager analyzes false-positive rates and/or false-negative rates and adjusts the risk score thresholds so that false-positive rates and/or false-negative rates satisfy and/or comply with one or more business rules, according to one embodiment.

The security system uses the authentication module to reduce potential fraud in the financial system by verifying users with information that is available to the financial system, according to one embodiment. For example, some user verification techniques include using third party verification services such as Experian®. However, service providers of tax return preparation systems have access to information that third party vendors do not. In one embodiment, the authentication module uses financial and/or personal information that is inaccessible to other verification services to verify/authenticate users to reduce the likelihood of potential fraud in user accounts of the financial system.

These and other embodiments of the tax return preparation system are discussed in further detail below.

By facilitating identification and reduction of potentially fraudulent activity (e.g., ATO, SIRF, etc.) in a financial system, implementation of embodiments of the present disclosure allows for significant improvement to the fields of data security, financial systems security, electronic tax return preparation, data collection, and data processing, according to one embodiment. As illustrative examples, by facilitating identification and reduction of potentially fraudulent activity, fraudsters can be deterred from criminal activity, financial system providers may retain/build trusting relationships with customers, customers may be spared financial losses, criminally funded activities may be decreased due to less or lack of funding, and tax refunds may be delivered to authorized recipients faster (due to less likelihood of unauthorized recipients). As another example, by identifying and implementing risk reducing actions, tax filer complaints to the Internal Revenue Service (“IRS”) and to financial system service providers may be reduced. As yet another example, some of the disclosed techniques facilitate real-time risk analysis, which enables the security system to reduce delays in executing preventative and/or remedial measures against would-be fraudsters. As a result, embodiments of the present disclosure allow for reduced communication channel bandwidth utilization and faster communications connections. Consequently, computing and communication systems implementing and/or providing the embodiments of the present disclosure are transformed into faster and more operationally efficient devices and systems.

In addition to improving overall computing performance, by facilitating identification and reduction of potentially fraudulent activity in a financial system, implementation of embodiments of the present disclosure represent a significant improvement to the field of providing an efficient user experience and, in particular, efficient use of human and non-human resources. As one illustrative example, by identifying and addressing fraudulent activity in user accounts, users can devote less time and energy to resolving issues associated with account abuse. Additionally, by identifying and addressing potential stolen identity refund fraud activity in a financial system, the financial system maintains, improves, and/or increases the likelihood that a customer will remain a paying customer and advertise the received services to the customer's peers, according to one embodiment. Consequently, using embodiments of the present disclosure, the user's experience is less burdensome and time consuming and allows the user to dedicate more of his or her time to other activities or endeavors.

### BRIEF DESCRIPTION OF THE DRAWINGS

FIG. 1 is a block diagram of software architecture for facilitating the identification and prevention of potentially fraudulent activity in a financial system, in accordance with one embodiment.

FIG. 2 is a block diagram of software architecture for facilitating the identification and prevention of potentially fraudulent activity in a tax return preparation system, in accordance with one embodiment.

FIG. 3 is a flow diagram of a process for improving risk score thresholds in a tax return preparation system to improve the performance of one or more predictive models in identifying potentially fraudulent activity, in accordance with one embodiment.

FIGS. 4A and 4B are a flow diagram of a process for facilitating the identification and prevention of potentially fraudulent activity in a financial system, in accordance with one embodiment.

FIGS. 5A and 5B are a flow diagram of a process for facilitating the identification and prevention of potentially fraudulent activity in a financial system, in accordance with one embodiment.

Common reference numerals are used throughout the FIGS. and the detailed description to indicate like elements. One skilled in the art will readily recognize that the above FIGs. are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs., which depict one or more exemplary embodiments. Embodiments may be implemented in many different forms and should not be construed as limited to the embodiments set forth herein, shown in the FIGs., and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for facilitating identification and prevention of potentially fraudulent activity in a financial system, according to various embodiments.

### Introductory System

Herein, a system (e.g., a software system) can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers/obtains data, from one or more sources and/or has the capability to analyze at least part of the data.

As used herein, the term system includes, but is not limited to the following: computing system implemented, and/or online, and/or web-based, personal and/or business tax preparation systems; computing system implemented, and/or online, and/or web-based, personal and/or business financial management systems, services, packages, programs, modules, or applications; computing system implemented, and/or online, and/or web-based, personal and/or business management systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

Specific examples of systems include, but are not limited to the following: TurboTax™ available from Intuit, Inc. of Mountain View, Calif.; TurboTax Online™ available from Intuit, Inc. of Mountain View, Calif.; QuickBooks™, available from Intuit, Inc. of Mountain View, Calif.; QuickBooks Online™, available from Intuit, Inc. of Mountain View, Calif.; Mint™, available from Intuit, Inc. of Mountain View, Calif.; Mint Online™, available from Intuit, Inc. of Mountain View, Calif.; and/or various other systems discussed herein, and/or known to those of skill in the art at the time of filing, and/or as developed after the time of filing. In one embodiment, data collected from users of TurboTax® and/or TurboTax® Online is not used with other service provider systems, such as Mint® or QuickBooks®.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the term “production environment” includes the various components, or assets, used to deploy, implement, access, and use, a given system as that system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the system in the production environment such as a data center, a cloud computing environment, a dedicated hosting environment, and/or one or more other computing environments in which one or more assets used by the application in the production environment are implemented; one or more computing systems or computing entities used to implement at least part of the system in the production environment; one or more virtual assets used to implement at least part of the system in the production environment; one or more supervisory or control systems, such as hypervisors, or other monitoring and management systems used to monitor and control assets and/or components of the production environment; one or more communications channels for sending and receiving data used to implement at least part of the system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the system in the production environment; one or more databases used to store data in the production environment; one or more internal or external services used to implement at least part of the system in the production environment; one or more backend systems, such as backend servers or other hardware used to process data and implement at least part of the system in the production environment; one or more modules/functions used to implement at least part of the system in the production environment; and/or any other assets/components making up an actual production environment in which at least part of the system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the system.

In various embodiments, one or more cloud computing environments are used to create, and/or deploy, and/or operate at least part of the system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets within one or more cloud or traditional computing environments.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience display” includes not only data entry and question submission user interfaces, but also other user experience features and elements provided or displayed to the user such as, but not limited to the following: data entry fields, question quality indicators, images, backgrounds, avatars, highlighting mechanisms, icons, buttons, controls, menus and any other features that individually, or in combination, create a user experience, as discussed herein, and/or as known in the art at the time of filing, and/or as developed after the time of filing.

As used herein, the term “user experience” includes not only the user session, interview process, interview process questioning, and/or interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

Herein, the term “party,” “user,” “user consumer,” and “customer” are used interchangeably to denote any party and/or entity that interfaces with, and/or to whom information is provided by, the disclosed methods and systems described herein, and/or a legal guardian of person and/or entity that interfaces with, and/or to whom information is provided by, the disclosed methods and systems described herein, and/or an authorized agent of any party and/or person and/or entity that interfaces with, and/or to whom information is provided by, the disclosed methods and systems described herein. For instance, in various embodiments, a user can be, but is not limited to, a person, a commercial entity, an application, a service, and/or a computing system.

As used herein, the term “predictive model” is used interchangeably with “analytics model” denotes one or more individual or combined algorithms or sets of equations that describe, determine, and/or predict characteristics of or the performance of a datum, a data set, multiple data sets, a computing system, and/or multiple computing systems. Analytics models or analytical models represent collections of measured and/or calculated behaviors of attributes, elements, or characteristics of data and/or computing systems.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein the term “system access data” denotes data that represents the activities of a user during the user's interactions with a financial system, and represents system access activities and the features and/or characteristics of those activities, according to various embodiments.

As used herein, the term “system access variation data” denotes data that is representative of differences in characteristics and/or features associated with one system access session and another system access session, according to various embodiments.

As used herein, the term “risk categories” denotes characteristics, features, and/or attributes of users or client systems, and represents subcategories of risk that may be used to quantify potentially fraudulent activity, according to various embodiments.

As used herein, the term “stolen identity refund fraud” (“SIRF”) denotes a creation of a financial system account using identification information (e.g., name, birth date, social security number, etc.) of an owner (e.g., person, business, or other entity) without the permission of the owner of the identification information, according to one embodiment. Stolen identity refund fraud is a technique that is employed by cybercriminals to obtain tax refunds from state and/or federal revenue services/agencies and/or from other government or private entities, according to one embodiment.

### Hardware Architecture

The present disclosure includes methods and systems for identifying and addressing potentially fraudulent (e.g., stolen identity refund fraud, account takeover, etc.) activity for a financial system, according to one embodiment. In one embodiment, a security system identifies and addresses potential stolen identity refund fraud activity in a tax return preparation system. To identify and address the potential fraudulent activity, the security system: receives system access data for a user account, generates one or more risk scores based on the system access data, and performs one or more risk reduction actions based on the likelihood of potential fraud that is represented by the one or more risk scores, according to one embodiment. In other words, when a user accesses a financial system, the financial system creates and stores data that represents the activities of the user during the user's interactions with the financial system. The created and stored data is system access data, according to one embodiment. As disclosed below, the security system uses one or more of system access data, user system characteristics data, a user's Internet Protocol (“IP”) address, and/or tax return filing characteristics, to generate risk scores and to perform risk reduction actions, according to various embodiments.

To facilitate the identification and/or reduction of potentially fraudulent activity, the security system uses features of a claim manager, a fraud investigation module, a risk score threshold manager, and/or an authentication module, according to one embodiment. These features increase the automation of risk determination, increase the likelihood of discovering potential fraudulent activity, and improve the performance/accuracy of fraud risk analysis, according to one embodiment.

To detect stolen identity refund fraud, the security system analyzes the data that represents the behavior of the user of a client system (e.g., user system) that accesses the financial system, according to one embodiment. Year-to-year changes in tax refund amount, income, age of a user account, other user account characteristics, and/or browsing behavior can be strong indicators of potential fraud activity, according to one embodiment. In one embodiment, the software system analyzes several factors, using multiple predictive models, to determine the likelihood of potentially fraudulent activity in a user account of the financial system.

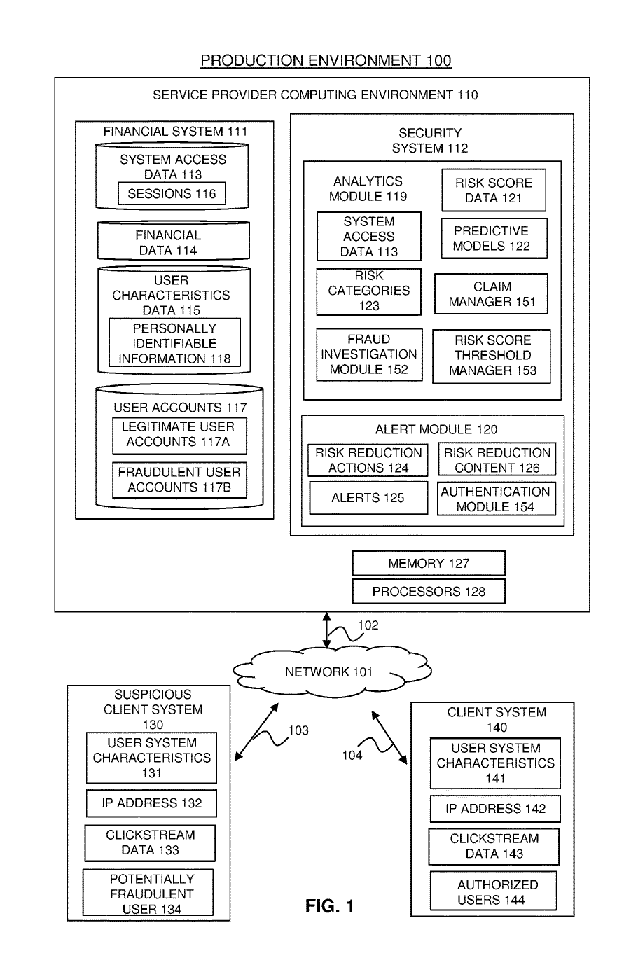

FIG. 1 is an example block diagram of a production environment 100 for facilitating identification and prevention of potentially fraudulent activity in a financial system, in accordance with one embodiment. The production environment 100 illustrates example communications between a suspicious client system, a client system and a service provider computing environment, to describe embodiments of how a security system may identify and address potential stolen identity refund fraud (“SIRF”) activity and/or potential account takeover (“ATO”) activity. The production environment 100 includes a service provider computing environment 110, a suspicious client system 130, and a client system 140 for facilitating identification and prevention of potentially fraudulent activity in a financial system, according to one embodiment. The computing environment 110 is communicatively coupled to the suspicious client system 130 and the client system 140 through a network 101 and through communications channels 102, 103, and 104, according to one embodiment.

The service provider computing environment 110 includes a financial system 111 and a security system 112 that are used to identify and address potentially fraudulent (e.g., SIRF, ATO, etc.) activity in user accounts in the financial system 111, according to one embodiment. The service provider computing environment 110 includes one or more centralized, distributed, and/or cloud-based computing systems that are configured to host the financial system 111 and/or the security system 112 for a service provider (e.g., Intuit®), according to one embodiment. The financial system 111 establishes one or more user accounts with one or more users of the client system 140 by communicating with the client system 140 through the network 101, according to one embodiment. The suspicious client system 130 also communicates with the financial system 111 to create and access one or more user accounts that are associated with authorized users and/or with the client system 140, according to one embodiment. The security system 112 uses information from the financial system 111 to identify the activities of the suspicious system 130 as potentially fraudulent, to determine the likelihood of potentially fraudulent activity from the suspicious client system 130, and to take one or more risk reduction actions to protect the account information in the financial system 111 (e.g., account information that is associated with the client system 140), according to one embodiment.

One or more fraudulent users (“fraudsters”) use the suspicious client system 130 and/or other client systems that are similar to the suspicious client system 130 to create user accounts in the financial system 111 that are based on identity information that has been stolen or taken from the legitimate owners of the identity information (e.g., authorized users). The fraudsters create fraudulent user accounts with the identity information and then use fictitious or embellished income information, work history, or other user characteristics to make the fraudulent user accounts file tax returns that will qualify for tax refunds. The fraudsters have the tax refunds directed to one or more bank or other financial institution accounts. Because the fraudsters are the ones who create the accounts, they will have access to the credentials needed to access the fraudulent user accounts in the financial system 111. The security system 112 is configured to monitor various characteristics of the fraudulent user accounts, of the suspicious client system, of the owners of the identity information, of the tax return filing, and the like, to identity and address potential stolen identity refund fraud, according to one embodiment.

One or more fraudulent users (“fraudsters”) use the suspicious client system 130 and/or other client systems that are similar to the suspicious client system 130 to access legitimate user accounts in the financial system 111 using credentials or identity information that has been stolen or taken from the legitimate owners of the identity information (e.g., authorized users). The fraudsters access the legitimate user accounts with the identity information or credentials and then use fictitious or embellished income information, work history, or other user characteristics to make the legitimate user accounts file tax returns that will qualify for tax refunds. The fraudsters have the tax refunds directed to one or more bank or other financial institution accounts. Because the fraudsters use correct credentials or have the correct identification information, they can obtain access the user accounts in the financial system 111. The security system 112 is configured to monitor various characteristics of the fraudulent user accounts, of the suspicious client system, of the owners of the identity information, of the tax return filing, and the like, to identity and address potential account takeover fraud, according to one embodiment.

The security system 112 includes a number of features that enable faster identification of potential fraud, that enable proactive detection of potential fraud, and the periodically or continuously improve/adjust the performance of the risk/fraud detection capabilities of the security system 112, according to one embodiment.

The financial system 111 provides one or more financial services to users of the financial system 111, according to one embodiment. Examples of financial services include, but are not limited to, tax return preparation services, personal financial management services, business financial management services, and the like. The financial system 111 enables users, such as the authorized users 144 of the client system 140, to interact with the financial system 111 based on one or more user accounts that are associated with the authorized users 144, according to one embodiment. The financial system 111 creates, acquires, receives, maintains and/or stores system access data 113, financial data 114, and user characteristics data 115 for user accounts 117, according to one embodiment.

The financial system 111 creates, stores, and manages the system access data 113, at least partially based on interactions of client systems with the financial system 111, according to one embodiment. The system access data 113 is stored as a table, a database, or some other data structure, according to one embodiment. The system access data 113 can include tens, hundreds, or thousands of features or characteristics associated with an interaction between a client system and the financial system 111, according to one embodiment. The system access data 113 is data that represents system access activities and the features and/or characteristics of those activities, according to one embodiment. The system access activities may occur before, during, and/or after a client system establishes a communications channel/connection with the financial system 111, according to one embodiment. The system access data 113 includes, but is not limited to, data representing: user entered data, event level data, interaction behavior, the web browser of a user's computing system, the operating system of a user's computing system, the media access control (“MAC”) address of the user's computing system, hardware identifiers of the user's computing system, user credentials used for logging in, a user account identifier, the IP address of the user's computing system, a session identifier, interaction behavior during prior sessions, interaction behavior using different computing systems to access the financial system 111, interaction behavior from IP addresses other than a current IP address, IP address characteristics, whether changes are made to user characteristics data, whether the changes that are made to user characteristics data increase a tax refund amount, whether the changes that are made to user characteristics data decrease a tax liability amount, user account characteristics, user account age, tax return preparation characteristics, tax return filing characteristics, and any other feature/characteristic of system access activity that is currently known at the time of filing or that may be known at a later time for interacting with a financial system, according to one embodiment. In one embodiment, event level data includes data that represents events such as filing a tax return, logging into a user account, entering information into the user account, navigating from one user experience page to another, and the like.

The system access data 113 associates, filters, orders, and/or organizes the features and/or characteristics of system access activities, at least partially based on one or more sessions 116, according to one embodiment. Each of the sessions 116 represent establishing a connection (e.g., a communications channel) between the financial system 111 and a client system with a web browser (e.g., Google Chrome®), according to one embodiment. Thus, a session is initiated if a user accesses one or more user interface displays (e.g., a webpage), and a session is terminated if a user closes some or all of the web browser windows or web browser tabs that are associated with the session that is initiated if the user accesses the one or more user interface displays, according to one embodiment. A session can also be terminated from the server side (e.g., by the financial system 111, the security system 112, and/or the service provider computing environment 110), according to one embodiment. Each session is associated with session identifier data that represents a session identifier, according to one embodiment. A session and a corresponding session identifier is added to the sessions 116, even if a user does not log into the financial system 111 using valid credentials (e.g., a username and a password), according to one embodiment. As result, the system access data 113 includes system access data/activities for computing systems of authorized users and for computing systems of potentially fraudulent users who access part of the financial system 111 without signing into or logging into a particular account, according to one embodiment.

In one embodiment, the security system 112 uses the system access data 113 that is based on one or more of the sessions 116 to identify and address potentially fraudulent activities, according to one embodiment. For example, the security system 112 analyzes the system access data 113 at least partially based on the number and characteristics of sessions entered into by a particular client system, according to one embodiment. A session-by-session analysis of system access data 113 can be used to show which client systems access multiple user accounts, in addition to the nature/behavior of the accesses, according to one embodiment.

In one embodiment, the system access data 113 associates, filters, orders, and/or organizes the features and/or characteristics of system access activities, at least partially based on one or more user accounts 117, according to one embodiment. Each of the user accounts 117 are legitimate user accounts 117A or fraudulent user accounts 117B, according to one embodiment. The legitimate user accounts 117A represent user accounts that are created by or authorized by owners of the identity information that is used to create the user accounts, according to one embodiment. The fraudulent user accounts 117B represent user accounts that are created in the financial system 111 by unauthorized users (e.g., fraudsters) to manufacture a tax return claim based on person's or other entity's identification information, according to one embodiment. Each of the user accounts 117 can be associated with one or more of the sessions 116, depending upon how many times one of the users interacts with the financial system 111 using the credentials associated with one of the user accounts 117, according to one embodiment. Each of the user accounts 117 is associated with one or more user credentials (e.g., a username and a password combination), according to one embodiment. As discussed above, briefly, one of the issues with stolen identity refund fraud is that the cybercriminal/fraudster has usually created the credentials for one or more of the user accounts 117, so that credential checks alone may be insufficient to detect stolen identity refund fraud activity. As described below, the security system 112 is configured to use characteristics and/or features of the system access activities associated with the system access data 113 to determine a likelihood of potentially fraudulent activity, according to one embodiment. In one embodiment, the security system 112 analyzes system access data 113 on an account-by-account basis to determine similarities in system access activities to label client systems and user accounts as potentially suspicious and to label navigation behaviors as potentially fraudulent.

The financial system 111 creates, stores, and/or manages the financial data 114 for users of the financial system 111, including the one or more authorized users 144, according to one embodiment. The financial data 114 is stored in a table, database, or other data structure, according to one embodiment. The financial data 114 includes, but is not limited to, data representing: one or more previous years' tax returns, and incomplete tax return, salary information, tax deduction information, tax liability history, personal budget information, partial or whole bank account information, personal expenditures, accounts receivable, accounts payable, annual profits for business, financial institution money transfer history, checking accounts, savings accounts, lines of credit, and the like, according to one embodiment. The financial system 111 receives and/or obtains the financial data 114 directly from one or more of the authorized users 144 and/or from the potentially fraudulent user 134, according to one embodiment. The financial system 111 receives and/or obtains the financial data 114 for one or more of the authorized users 144 and/or from the potentially fraudulent user 134 after or while setting up one or more user accounts 117, according to one embodiment. The financial data 114 is organized/keyed off of one or more of the user accounts 117, according to one embodiment. The financial data 114 can include fraudulent financial data if fraudulent users enter fictitious information in order to increase the likelihood and amount of tax refunds, according to one embodiment.

The financial system 111 creates, stores, and/or manages the user characteristics data 115 that is associated with users of the financial system 111, including the one or more authorized users 144, according to one embodiment. The user characteristics data 115 is stored in a table, database, or some other data structure, according to one embodiment. The user characteristics data 115 is sorted, filtered, and/or organized based on one or more of the user accounts 117, in the data structure, according to one embodiment. The user characteristics data 115 includes personally identifiable information 118 (“PII”) for each of the authorized users 144, according to one embodiment. Personally identifiable information includes, but is not limited to, a Social Security number, employer identification number, driver's license number, home address, combinations of other user characteristics data 115, or any other information that can be used to distinguish one user (e.g., person or organization) from another, according to one embodiment. In addition to personally identifiable information 118, the user characteristics data 115 includes, but is not limited to, data representing: browsing/navigation behavior within the financial system 111, type of web browser, type of operating system, manufacturer of computing system, whether the user's computing system is a mobile device or not, a user's name, a Social Security number, government identification, a driver's license number, a date of birth, an address, a zip code, a home ownership status, a marital status, an annual income, a job title, an employer's address, spousal information, children's information, asset information, medical history, occupation, information regarding dependents, salary and wages, interest income, dividend income, business income, farm income, capital gain income, pension income, individual retirement account (“IRA”) distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, in a financial system or in providing one or more financial services, according to various embodiments. According to one embodiment, the security system 112 uses the user characteristics data 115 and/or the financial data 114 and/or the system access data 113 to determine a likelihood of potentially fraudulent activity by one or more client systems, such as the suspicious client system 130, according to one embodiment. In one embodiment, the user characteristics data 115 also includes information about the fraudulent users that is collected as the fraudulent users interact with the financial system 111.

The client system 140 is used to communicate with and/or interact with the financial system 111, according to one embodiment. The client system 140 is representative of one of hundreds, thousands, or millions of client systems used by users to access the financial system 111, according to one embodiment. The client system 140 includes user system characteristics 141, an Internet Protocol (“IP”) address 142, clickstream data 143, and authorized users 144, according to one embodiment. In one embodiment, only one authorized user uses the client system 140 to access the financial system. In one embodiment, the client system 140 is a family computer or a public computer that is used by multiple authorized users to access the financial system 111.

The user system characteristics 141 include one or more of an operating system, a hardware configuration, a web browser, information stored in one or more cookies, the geographical history of use of the client system 140, the IP address 142, and other forensically determined characteristics/attributes of the client system 140, according to one embodiment. The user system characteristics 141 are represented by a user system characteristics identifier that corresponds with a particular set of user system characteristics during one or more of the sessions 116 with the financial system 111, according to one embodiment. Because the client system 140 may use different browsers or different operating systems at different times to access the financial system 111, the user system characteristics 141 for the client system 140 may be assigned several user system characteristics identifiers, according to one embodiment. The user system characteristics identifiers are called the visitor identifiers (“VIDs”), according to one embodiment.

The IP address 142 can be static, can be dynamic, and/or can change based on the location (e.g., a coffee shop) for which the client system 140 accesses the financial system 111, according to one embodiment. The financial system 111 and/or the security system 112 may use an IP address identifier to represent the IP address and/or additional characteristics of the IP address 142, according to one embodiment.

The clickstream data 143 represents the browsing/navigation behavior of one or more of the authorized users 144 while interacting with the financial system 111, according to one embodiment. The clickstream data 143 is captured and/or stored in the system access data 113 and/or the user characteristics data 115, according to one embodiment.

When a new one of the user accounts 117 is created, the financial system 111 stores one or more of the user system characteristics 141, the IP address 142, and the clickstream data 143, and associates these features of the client system 140 with one or more of the authorized users 144 and with one or more of the user accounts 117 that correspond with the authorized users 144, according to one embodiment. The security system 112 detects and uses variations in the characteristics of the client system 140 and changes in the behavior of the authorized users 144 to detect and identify potentially fraudulent activity that corresponds with stolen identity refund fraud activity or account takeover for one or more user accounts 117 and/or for one or more of the authorized users 144, according to one embodiment.

The suspicious client system 130 is similar to the client system 140, in that the suspicious client system 130 includes user system characteristics 131, an IP address 132, and clickstream data 133, according to one embodiment. The suspicious client system 130 includes a potentially fraudulent user 134, according to one embodiment. The suspicious client system 130 is representative of just one of potentially multiple client systems that may be used by unauthorized users to create fraudulent user accounts 117B in the financial system 111 with identity information of other people or entities (e.g., business entities, schools, etc.), according to one embodiment. The suspicious client system 130 is representative of just one of potentially multiple client systems that may be used by unauthorized users to fraudulently access legitimate user accounts 117A in the financial system 111 with identity information or credentials of the authorized users 144, according to one embodiment. Of course, although one potentially fraudulent user 134 is specifically called out, multiple potentially fraudulent users can be sharing the suspicious client system 130 to conduct potentially fraudulent or to conduct fraudulent activity with the financial system 111, according to one embodiment. The user system characteristics 131 are associated with a user system characteristics identifier, which can be generated based on a combination of the hardware and software used by the suspicious client system 130 to access the financial system 111 during one or more sessions 116, according to one embodiment. The user system characteristics 131 are associated with a user system characteristics identifier, which can be generated based on a combination of the hardware and software used by the suspicious client system 130 to access one or more of the user accounts 117, according to one embodiment. As discussed above, the system access data 113 and/or the user characteristics data 115 include the user system characteristics 131, the IP address 132, and the clickstream data 133 for the potentially fraudulent user 134 and/or for the suspicious client system 130, according to one embodiment. As described, the security system 112 uses one or more of the system access data 113, the financial data 114, and the user characteristics data 115, to determine the likelihood that the suspicious client system 130 and/or the potentially fraudulent user 134 is participating in potentially fraudulent activities during his or her use of the financial system 111, according to one embodiment.

To determine the likelihood that a suspicious client system 130 (or any other client system) is performing potential stolen identity refund fraud activities, the security system 112 uses an analytics module 119 and an alert module 120, according to one embodiment. Although embodiments of the functionality of security system 112 will be described in terms of the analytics module 119 and the alert module 120, the security system 112, the financial system 111, and/or service provider computing environment 110 may use one or more alternative terms and/or techniques for organizing the operations, features, and/or functionality of the security system 112 that is described herein. In one embodiment, the security system 112 (or the functionality of the security system 112) is partially or wholly integrated/incorporated into the financial system 111.

The security system 112 generates risk score data 121 for system access activities that are represented by the system access data 113, to determine a likelihood of potential fraudulent activity in the financial system 111, according to one embodiment. The analytics module 119 and/or the security system 112 acquire the system access data 113 from the financial system 111 and/or from a centralized location where the system access data 113 is stored for use by the financial system 111, according to one embodiment. The analytics module 119 and/or the security system 112 applies the system access data 113 to one or more predictive models 122, to generate the risk score data 121 that represents one or more risk scores, according to one embodiment. The analytics module 119 and/or the security system 112 defines the likelihood of potential fraudulent activity at least partially based on the risk scores (represented by the risk score data 121) that are output from the one or more predictive models 122, according to one embodiment. In one embodiment, the analytics module 119 uses a single risk score to determine the likelihood of potential fraudulent activity. In one embodiment, the analytics module 119 uses a combination of two or more risk scores to determine the likelihood of potential fraudulent activity.

The analytics module 119 and/or the security system 112 uses one or more of the predictive models 122 to generate risk score data 121 for one or more risk categories 123, according to one embodiment. The risk categories 123 represent characteristics, features, and/or attributes of the authorized users 144 of the client system 140, of the suspicious client system 130, and/or of the potentially fraudulent user 134, according to one embodiment. The risk categories 123 include, but are not limited to, user system characteristics, user characteristics, tax return filing characteristics, IP address characteristics, age of user account, and user account characteristics, according to one embodiment. The risk categories 123 have risk category identifiers that include, but are not limited to, a user system characteristics identifier (a.k.a., visitor ID or “VID”), an IP address identifier, and a user account identifier (a.k.a., auth ID), according to one embodiment. In other words, each of the predictive models 122 receives the system access data 113 (or other input data) and generates one risk score (represented by the risk score data 121) for a different one of the risk categories 123, according to one embodiment. To illustrate with an example, the analytics module 119 receives system access data 113 (representative of tens, hundreds, or thousands of characteristics or features of system access activities for a session), the analytics module 119 applies the system access data 113 to one of the predictive models 122, the predictive model generates a risk score of 0.72 (represented by the risk score data 121) for the IP address 132 of the suspicious client system 130, and the analytics module 119 and/or the security system 112 determines whether a risk score of 0.72 is a strong enough indication of a security threat to warrant performing one or more risk reduction actions.

The security system 112 creates the user system characteristics identifier, as one example of a risk category identifier, to track the system access activities associated with a particular computing system configuration, according to one embodiment. If for example, one of the authorized users 144 has an account with the financial system 111 and accesses the financial system 111 with the same user system characteristics identifier consistently, then the security systems 112 may be configured to raise the risk score associated with the user system characteristics identifier if a user (e.g., a potentially fraudulent user 134) uses a completely different user systems characteristic identifier to access the account, according to one embodiment. The risk score associated with the user system characteristics identifier is increased even further, if other browsing behaviors (e.g., uncharacteristically accesses the financial system 111 in the middle of the night) also change at the same time that a new/unknown user system characteristics identifier accesses and/or modifies an account for the authorized user, according to one embodiment. The security system 112 is particularly sensitive to age of account, user account characteristics, user entered data, event level data, and interaction behavior, according to one embodiment. In other words, although the security system 112 is configured to determine likelihoods of potentially fraudulent activity by using multifactor analysis, some characteristics may be more dominant indicators of potential stolen identity refund fraud activity for an account, according to one embodiment.

The security system 112 creates the IP address identifier, as one example of a risk category identifier, to track the system access activities associated with a particular IP address, according to one embodiment. The IP address identifier may be data that simply represents the IP address of the computing system that accesses the financial system 111, according to one embodiment. The IP address identifier is derived from or at least partially based on the IP address, according to one embodiment. The security system 112 uses the IP address identifier as a characteristic of system access activity for user, according to one embodiment. If, for example, multiple user accounts 117 are created from a single IP address, then the security system 112 might increase the risk score for the IP address indicator for any accounts created or accessed from that IP address, according to one embodiment. If for example, an owner of a particular identity information consistently uses a fixed IP addresses associated with a corporation to create or access a user account 117, then a newly created account for the particular identity information from dynamically allocated IP addresses, (such as those that may be allocated from Amazon Web Services) may cause the security system 112 to increase the risk score for the IP address indicator for the created user account, according to one embodiment. Other characteristics of the IP address indicator or of the IP address, such as whether the IP address is associated with a residence or a corporation instead of a coffee shop or a library, can be used to assess the level of risk assigned to the IP address that is being used to create and/or access a user account in the financial system 111, according to one embodiment. Because the security system 112 monitors IP addresses that are used to initiate the sessions 116 with the financial system 111, the financial system 111 and the security system 112 may have system access data 113 for an IP address and other information about a suspicious client system before the IP address is even used to log into or create an account, according to one embodiment. The session-based information can also be used by the security system 112 to determine a level of risk is associated with or assigned to an IP address indicator, according to one embodiment.

The security system 112 creates the user account identifier (e.g., an “auth ID”), as one example of a risk category identifier, to track the system activities associated with a particular user account, according to one embodiment. The account identifier can include a username, a password, a combination of username and password, a cryptographic hash function applied to a username and/or a password, identity information (e.g., a social security number or date of birth), or some other data that is at least partially based on credentials of an authorized user who has an account, according to one embodiment. The security system 112 uses the user account identifier and/or the IP address identifier and/or the user system characteristics identifier to track and compare prior year's activities with current activities, according to one embodiment. The security system 112 tracks and compares activities such as the time of day a user logs in, the time of year a user logs in, the number of times a user logs in, the types of changes made to the user's account, changes that may correspond with increasing an amount of money that is owed to the user, and the like, according to one embodiment. Even if a new account is created for particular identity information, the security system 112 can track year to year behavior differences by comparing the system access data 113 associated with the person or entity (i.e., owner) of the identity information, according to one embodiment. The combination of receiving, storing, monitoring, and comparing system access activities (represented by system access data 113 and/or user characteristics data 115) enables the security system 112 to detect and identify irregularities in user behavior and assign likelihoods of risk associated with the system of access activities, according to one embodiment.

Each of the predictive models 122 can be trained to generate the risk score data 121 based on one or more of the system access data 113, the financial data 114, tax return filing data, user account data, and/or the user characteristics data 115, according to one embodiment. Each of the one or more predictive models 122 are trained generate a risk score or risk score data 121 for one particular risk category (e.g., user system characteristics, tax return filing, user characteristics, IP address, user account, etc.), according to one embodiment. The risk score data 121 represents a risk score that is a number (e.g., a floating-point number) ranging from 0-1 (or some other range of numbers), according to one embodiment. The closer the risk score is to 0, the lower the likelihood is that potentially fraudulent activity has occurred for a particular risk category. The closer the risk score is to 1, the higher the likelihood is that potentially fraudulent activity has occurred for a particular risk category. Returning to the example of a risk score of 0.72 for the IP address 132 (e.g., the IP address identifier), it would be more likely than not that the IP address 132 has been used to perform actions that one or more of the predictive models 122 has been trained to identify as potentially fraudulent, according to one embodiment.

Each of the predictive models 122 is trained using information from the financial system 111 that has been identified or reported as being linked to some type of fraudulent activity, according to one embodiment. Customer service personnel or other representatives of the service provider receive complaints from a user when the user accounts for the financial system 111 do not work as expected or anticipated (e.g., a tax return has been filed from a user's account without their knowledge). When customer service personnel look into the complaints, they may occasionally identify user accounts that have been created under a person's or other entity's name and/or government identification, without the person or entity's knowledge. By obtaining identity information of a person or entity, a fraudster may be able to create fraudulent user accounts 117B and create and/or file tax returns with the identity information without the permission of the owner of the identity information. When an owner of the identity information creates and/or uses a legitimate user account to prepare and/or file a tax return, the owner of the identity information may receive notification that a tax return has already been prepared and/or filed for their identity. A complaint about such a situation is identified or flagged for potential or actual stolen identity refund fraud activity, according to one embodiment. One or more predictive model building techniques is applied to the system access data, financial data, and/or user characteristics data to generate one or more of the predictive models 122 for one or more of the risk categories 123, to identify potentially fraudulent access to the legitimate user accounts 117A, and to identify fraudulent user accounts 117B that have been created by fraudsters using legitimate identity information, according to one embodiment. The one or more predictive models 122 are trained using one or more of a variety of machine learning techniques including, but not limited to, regression, logistic regression, decision trees, artificial neural networks, support vector machines, linear regression, nearest neighbor methods, distance based methods, naive Bayes, linear discriminant analysis, k-nearest neighbor algorithm, or another mathematical, statistical, logical, or relational algorithm to determine correlations or other relationships between the likelihood of potential stolen identity refund fraud activity and the system access data 113, the financial data 114, and/or the user characteristics data 115, according to one embodiment.

The security system 112 expedites risk reduction actions/procedures and trains the predictive models 122 using fraud claims data that is received from users with the claim manager 151, according to one embodiment. The fraud claims data is data that represents potentially fraudulent activities that are reported by users, according to one embodiment. The fraud claims data represents a flagged user account, i.e., the user account that has been flagged for potentially fraudulent activity, according to one embodiment. Fraud claims data can be submitted to the security system with customer support representatives, but the claim manager 151 enables self-reporting of suspicious/potentially fraudulent activities, according to one embodiment.

The claim manager 151 provides a user experience display to users to enable the users to enter fraud claims data into the security system 112, according to one embodiment. The user experience display provides buttons, text boxes, and other user experience elements to progress users through a fraud claims submission interview, according to one embodiment. The fraud claim submission interview includes questions, explanations, and audio/video resources to help the user enter in information such as the user's identity information, username, symptoms of the suspicious/potentially fraudulent activities, name, birth date, and the like, according to one embodiment. During the fraud claim submission interview, the claim manager 151 acquires user system characteristics data about the user computing system that is used to submit the claim, which can be used to identify, deemphasize, and remove fraud claims submitted by fraudsters, according to one embodiment. The fraud claims data is then used by the security system 112 to execute risk reduction actions to reduce further potential fraudulent activity on the user account, and is used to train the predictive models 122 to enable the predictive models to catch the fraudulent activity in the future, according to one embodiment.

The security system 112 uses the fraud investigation module 152 to identify additional user accounts that have potentially been affected by fraudulent activity, according to one embodiment. Fraud claims data acquired by the claim manager 151 and/or received from customer support representatives is analyzed by the fraud investigation module 152, according to one embodiment. The fraud investigation module 152 analyzes characteristics of the flagged/reported user account, analyzes characteristics of other user accounts 117, and identifies additional user accounts that may be associated with fraudulent activity based on the similarity between characteristics of the flagged user account and the additional user accounts, according to one embodiment. In one embodiment, the additional user accounts have 2 or more characteristics that are similar to the flagged user account, according to one embodiment.

The fraud investigation module 152 applies each of the additional user accounts to the predictive models 122 to obtain risk score data 121 for each of the additional user accounts, according to one embodiment. By applying the additional user accounts to the predictive models 122, the fraud investigation module 152 can verify or dismiss whether or not the additional user accounts have been subjected to fraudulent activity, according to one embodiment. The fraud investigation module 152 provides the additional user accounts (or identifiers associated with the additional user accounts) to a fraud investigation team for verification of potentially fraudulent activity, according to one embodiment.

In one embodiment, the fraud investigation module 152 is a service that is received from a third-party service provider. In one embodiment, one or more of the features of the fraud investigation module 152 are received from a third party service provider. In one embodiment, some of the features of the investigation module 152 are contributed by the service provider computing environment 110 and some of the features are provided by a third party service provider.

The analytics module 119 and/or the security system 112 can use the risk scores represented by the risk score data 121 in a variety of ways, according to one embodiment. In one embodiment, a determination to take corrective action or to take risk reduction actions is based on a risk score for one of the risk categories 123 (e.g., IP address). In one embodiment, a determination to take remedial/protective/corrective action or to take risk reduction action is based on a combination of risk scores for two or more of the risk categories 123 (e.g., IP address and user system characteristics).

The predictive models 122 are applied to existing sessions 116 that represent a low likelihood for fraudulent activity as well as to existing sessions 116 that represent a high likelihood for fraudulent activity, to define risk score thresholds to apply to the risk score data 121, according to one embodiment. In one embodiment, the risk score data 121 is compared to one or more predefined risk score thresholds to determine if one or more of the risk categories 123 has a high enough likelihood of potential fraudulent characteristics to warrant performing risk reduction actions. Examples of risk score thresholds include 0.8 for user system characteristics, 0.95 for an IP address, and 0.65 for a user account, according to one example of an embodiment. These values are merely illustrative and are determined based on applying the predictive models 122 to existing system access data 113 and/or are determined based on user satisfaction/complaints about the received financial services, according to one embodiment.

By defining and applying risk score thresholds to the risk score data 121, the security system 112 can control the number of false-positive and false-negative determinations of potentially fraudulent activity between client systems and the financial system 111, according to one embodiment. When a suspicious client system is identified as having a high likelihood of association with potentially fraudulent activity, the security system 112 executes one or more risk reduction actions to protect the owner of the identity information that is associated with the user account, according to one embodiment. However, if the security system 112 flags system access activity as potentially fraudulent when the system access activity is not fraudulent, then the flagged activity is a false-positive and the authorized user is inconvenienced with proving his or her identity and/or with being blocked from accessing the financial system 111, according to one embodiment. Thus, tuning the financial system 111 and/or the risk score thresholds to control the number of false-positive determinations will improve users' experience with the financial system 111, according to one embodiment.

A less-desirable scenario than flagging a session as false-positive might be flagging a session as false-negative for potentially fraudulent activity between client systems in the financial system 111, according to one embodiment. If the security system 112 flags system access activity as not being potentially fraudulent when in fact the system activity has a high likelihood of potentially fraudulent, then the non-flagged activity is a false-negative, and the owner of the identity information may not be able to obtain his or her tax refund until the fraudulent activity is resolved, according to one embodiment. Thus, tuning the financial system and/or the risk score thresholds to control the number of false-negative determinations will improve users' experience with the financial system 111, according to one embodiment.

In one embodiment, a risk score threshold manager 153 determines and tunes risk score thresholds that are applied to the risk score data 121, according to one embodiment. The risk score threshold manager 153 receives business rules and determines the risk score thresholds at least partially based on the business rules, according to one embodiment. An example of a business rule is to have a false-negative rate that is less than 0.05 (i.e., 5%), according to one embodiment. The business rules may be established by business leaders of the service provider based on profit margins, customer feedback, and/or corporate goals, according to one embodiment. The risk score threshold manager 153 evaluates the false-negative rates and false-positive rates that result from a first set of risk score thresholds, compares the false-negative rates and/or false-positive rates to the business goals, and adjusts one or more of the risk score thresholds up and/or down in order to align the operation of the security system 112 with the business goals established by the service provider, according to one embodiment. In one embodiment, the risk score threshold manager 153 uses a receiver operating characteristics (“ROC”) curve of one or more of the predictive models 122 to initially determine the performance of the predictive models 122 and to initially establish risk score thresholds to apply to the risk score data 121, according to one embodiment. Because the receiver operating characteristics of the predictive models 122 are at least partially based on prior data and prior user experiences, the receiver operating characteristics of the predictive models 122 can be somewhat theoretical or can be a good estimate of how the predictive models 122 will operate, according to one embodiment. By tuning the risk score thresholds, the risk score threshold manager 153 improves the performance of the security system 112 in identifying and addressing potentially fraudulent activity in the financial system 111, according to one embodiment.

The security system 112 uses the alert module 120 to execute one or more risk reduction actions 124, upon determining that all or part of the risk score data 121 indicates a likelihood of potentially fraudulent activity occurring in the financial system 111 for at least one of the user accounts 117, according to one embodiment. The alert module 120 is configured to coordinate, initiate, or perform one or more risk reduction actions 124 in response to detecting and/or generating one or more alerts 125, according to one embodiment. The alert module 120 and/or the security system 112 is configured to compare the risk score data 121 to one or more risk score thresholds to quantify the level of risk associated with one or more system access activities and/or associated with one or more client systems, according to one embodiment. The alerts 125 include one or more flags or other indicators that are triggered, in response to at least part of the risk score data 121 exceeding one or more risk score thresholds, according to one embodiment. The alerts 125 include an alert for each one of the risk categories 123 that exceeds a predetermined and/or dynamic risk score threshold, according to one embodiment. The alerts 125 include a single alert that is based on a sum, an average, or some other holistic consideration of the risk scores associated with the risk categories 123, according to one embodiment.

If at least part of the risk score data 121 indicates that potentially fraudulent activity is occurring or has occurred for one of the user accounts 117, the alert module uses risk reduction content 126 and performs one or more risk reduction actions 124 to protect one or more of the authorized users 144, according to one embodiment. The risk reduction content 126 includes, but is not limited to, banners, messages, audio clips, video clips, avatars, other types of multimedia, and/or other types of information that can be used to notify a system administrator, customer support, an authorized user associated with an account that is under inspection, a government entity, a state or federal revenue service, and/or a potentially fraudulent user 134, according to one embodiment. The risk reduction actions 124 include, but are not limited to, challenging the authentication of the user, removing multi-factor authentication options (e.g., removing email as a multi-factor authentication option), increasing the difficulty of multi-factor authentication options, sending a text message to an owner of identity information, logging a user out of a session with the financial system 111, ending a session, blocking access to the financial system 111, suspending credentials (at least temporarily) of an authorized user, preventing a user from making one or more changes to one or more user accounts 117, preventing (at least temporarily) a user from executing one or more operations within the financial system 111 (e.g., preventing the user from filing a tax return or from altering which financial institution account is set up to receive a tax refund), suspending a tax return filing, suspending a tax refund, and the like, according to various embodiments.

In one embodiment, the security system 112 and/or the alert module 120 uses an authentication module 154 to challenge the authentication of the user and/or to verify that a user is authorized to use the identification information and/or the user account that the user is using to access the financial system 111, according to one embodiment. The authentication module 154 is configured to use system access data 113, financial data 114, and/or user characteristics data 115 to generate questions for a user to respond to in order to verify that the user has sufficient knowledge of the identification information to likely be the authorized user of a user account, according to one embodiment. Some third-party service providers, e.g., Experian, provide user verification services. However, the third party service providers lack the quantity of information that is obtained from users during the preparation of a tax return. The authentication module 154 also has the capacity to search through prior tax return filings to generate questions that an authorized user would be likely to know but that would take a long time for an unauthorized user to research in order to respond correctly to, according to one embodiment. The service provider computing environment 110 also includes financial data 114 in user characteristics data 115 that can be obtained from other services that the service provider is providing to users. In one embodiment, the authentication module 154 uses user data that is obtained from other service provider services in order to verify/authenticate that a user is authorized to access a particular user account, according to one embodiment. For example, the service provider computing environment 110 can be associated with the service provider that provides personal financial management services and/or business financial management services, according to one embodiment. An additional advantage of leveraging the user data that is stored by the service provider computing environment 110 is that much of the information that is by third-party verification services can be determined by accessing public records and by performing public record searches for an individual, whereas, user characteristics data 115, and/or the financial data 114, may be unique to the financial system 111, and/or other services provided by the service provider computing environment 110, according to one embodiment.

In one embodiment, the security system 112 analyzes system access data 113 in a batch mode. For example, the security system 112 periodically (e.g., at the end of each day) fetches or receives one or more of the system access data 113, the financial data 114, and the user characteristics data 115 to perform stolen identity refund fraud analysis, according to one embodiment.

In one embodiment, the security system 112 provides real-time fraudulent activity identification and remediation services. Each time a user account is created or accessed, the financial system 111 executes and/or calls the services of the security system 112 to generate risk score data 121 for the client system that accesses the account, according to one embodiment. In one embodiment, the security system 112 continuously or periodically (e.g., every 1, 5, 10, 15 minutes, etc.) applies system access data to the one or more predictive models 122 to generate risk score data 121 for users as they access or attempt to access the financial system 111.

The service provider computing environment 110 and/or the financial system 111 and/or the security system 112 includes memory 127 and processors 128 to support operations of the financial system 111 and/or of the security system 112 in facilitating the identification and intervention of potentially fraudulent activities in the financial system 111, according to one embodiment. In one embodiment, the security system 112 includes instructions that are represented as data that are stored in the memory 127 and that are executed by one or more of the processors 128 to perform a method of identifying and addressing potentially fraudulent activities in the financial system 111.

By receiving various information from the financial system 111, analyzing the received information, quantifying a likelihood of risk based on the information, and performing one or more risk reduction actions 124, the security system 112 works with the financial system 111 to improve the security of the financial system 111, according to one embodiment. In addition to improving the security of the financial system 111, the security system 112 protects financial interests of customers of the service provider, to maintain and/or improve consumer confidence in the security and functionality of the financial system 111, according to one embodiment. Furthermore, the security system 112 addresses the long-standing an Internet-centric problem of cyber criminals stealing and using the identity information of people and business entities to perform unauthorized actions (e.g., create user accounts and steal electronically transferable funds from legitimate/rightful owners), according to one embodiment.

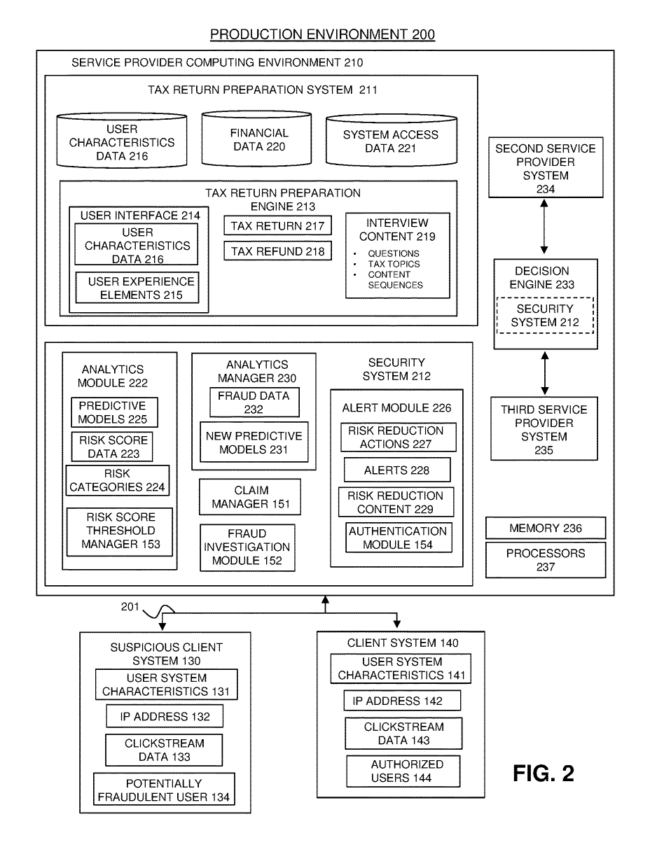

FIG. 2 illustrates a production environment 200 for facilitating the identification and prevention of potential fraudulent activities in a tax return preparation system, as a particular example of a financial system, according to one embodiment. The production environment 200 includes a service provider computing environment 210, the suspicious client system 130 (of FIG. 1), and the client system 140 (of FIG. 1), according to one embodiment. The service provider computing environment 210 is communicatively coupled to one or more of the suspicious client system 130, and the client system 140 through one or more communications channels 201 (e.g., the Internet), according to one embodiment. The service provider computing environment 210 includes a tax return preparation system 211 and a security system 212 for facilitating the identification and prevention of potential fraudulent activities in the tax return preparation system 211, according to one embodiment.

The tax return preparation system 211 progresses users through a tax return preparation interview to acquire user characteristics data, to prepare tax returns for users, and/or to assist users in obtaining tax credits and/or tax refunds, according to one embodiment. The tax return preparation system 211 is one embodiment of the financial system 111 (shown in FIG. 1).

The tax return preparation system 211 uses a tax return preparation engine 213 to facilitate preparing tax returns for users, according to one embodiment. The tax return preparation engine 213 provides a user interface 214, by which the tax return preparation engine 213 delivers user experience elements 215 to users to facilitate receiving user characteristics data 216 from users, according to one embodiment. The tax return preparation engine 213 uses the user characteristics data 216 to prepare a tax return 217, and to (when applicable) assist users in obtaining a tax refund 218 from state and federal revenue services, according to one embodiment. The tax return preparation engine 213 populates the user interface 214 with user experience elements 215 that are selected from interview content 219, according to one embodiment. The interview content 219 includes questions, tax topics, content sequences, and the like for progressing users through a tax return preparation interview, to facilitate the preparation of a tax return 217 for each user, according to one embodiment.

The tax return preparation system 211 stores the user characteristics data 216 in a database, for use by the tax return preparation system 211 and/or for use by the security system 212, according to one embodiment. The user characteristics data 216 is an implementation of the user characteristics data 115 (shown in FIG. 1), which is described above, according to one embodiment. The user characteristics data 216 is a table, database, or other data structure, according to one embodiment.

The tax return preparation system 211 receives and stores financial data 220 in a table, database, or other data structure, for use by the tax return preparation system 211 and/or for use by the security system 212, according to one embodiment. The financial data 220 includes the financial data 114 (shown in FIG. 1), according to one embodiment. The financial data 220 includes, but is not limited to, account identifiers, bank accounts, prior tax returns, and the financial history of users of the tax return preparation system 211, according to one embodiment.

The tax return preparation system 211 acquires and stores the system access data 221 in a table, database, or other data structure, for use by the tax return preparation system 211 and/or for use by the security system 212, according to one embodiment. The system access data 221 includes the system access data 113 (shown in FIG. 1), according to one embodiment. The system access data 221 includes, but is not limited to, data representing one or more of: user system characteristics, IP addresses, tax return filing characteristics, user account characteristics, session identifiers, browsing behavior, user entered data, event level data, and user credentials, according to one embodiment.

The service provider computing environment 210 uses the security system 212 to identify and address potential stolen identity refund fraud activity in the tax return preparation system 211, according to one embodiment. The security system 212 is an implementation of the security system 112 (shown in FIG. 1), according to one embodiment. The security system 212 requests and/or acquires information from the tax return preparation system 211 and determines the likelihood of potential stolen identity refund fraud activity for the interactions of one or more client systems with the tax return preparation system 211, according to one embodiment. The security system 212 is part of the same service provider computing environment as the tax return preparation system 211, and therefore obtains access to the user characteristics data 216, the financial data 220, and system access data 221, by generating one or more data requests (e.g., database queries) in the service provider computing environment 210, according to one embodiment.

The security system 212 uses an analytics module 222 to analyze one or more of the system access data 221, the financial data 220, and the user characteristics data 216 to determine risk score data 223 for the interactions of client systems with the tax return preparation system 211, according to one embodiment. The risk score data 223 represents risk scores that are a likelihood of potential fraudulent activity for one or more risk categories 224 that are associated with a user account in the tax return preparation system 211, according to one embodiment. The analytics module 222 transforms one or more of the system access data 221, the financial data 220, and the user characteristics data 216 into the risk score data 223, according to one embodiment. The analytics module 222 applies one or more of the system access data 221, the financial data 220, and the user characteristics data 216 to one or more predictive models 225 in order to generate the risk score data 223, according to one embodiment. In one embodiment, the one or more predictive models 225 transform input data into risk score data 223 that represents one or more risk scores for one or more risk categories 224 for one or more user accounts in the tax return preparation system 211. Each of the predictive models 225 generates risk score data 223 that is associated with a single one of the risk categories 224 (e.g., user system characteristics, IP address, user account, etc.), according to one embodiment. The analytics module 222 is one implementation of the analytics module 119, according to one embodiment. The analytics module 222 includes some or all of the features of the analytics module 119, according to one embodiment.

The analytics module 222 includes the risk score threshold manager 153, according to one embodiment. The analytics module 222 uses the risk score threshold manager 153 to determine and adjust/improve risk score thresholds that are applied to the risk score data 223, according to one embodiment. The risk score threshold manager 153 adjusts the risk score thresholds to improve performance of the security system 212 until and/or while updated predictive models are trained, according to one embodiment.

The security system 212 uses an alert module 226 to perform one or more risk reduction actions 227, in response to determining that potential stolen identity refund fraud activity is occurring or has occurred in the tax return preparation system 211 for one or more user accounts, according to one embodiment. The alert module 226 receives alerts 228, risk score data 223, or other notifications that potential stolen identity refund fraud activity has occurred, according to one embodiment. The alert module 226 uses risk reduction content 229 (e.g., messages, multimedia, telecommunications messages, etc.) while performing one or more of the risk reduction actions 227, according to one embodiment. The alert module 226 is one implementation of the alert module 120 (shown in FIG. 1), according to one embodiment. The alert module 226 includes one or more of the features/functionality of the alert module 120 (shown in FIG. 1), according to one embodiment.

The security system 212 uses an analytics manager 230 to train new predictive models 231 based on fraud data 232, according to one embodiment. The new predictive models 231 are used to replace the predictive models 225 as the analytics manager 230 trains/updates predictive models for use in the security system 212, according to one embodiment. The fraud data 232 is data that is verified (e.g., by customer service representatives) as being associated with fraudulent activity (e.g., stolen identity refund fraud activity) in the tax return preparation system 211, according to one embodiment.

The analytics manager 230 receives the fraud data 232 from the claim manager 151, according to one embodiment. The claim manager 151 receives reports of fraudulent activity from users of the tax return preparation system 211 and gathers information (e.g., user name, user account identification, identification information, description of fraudulent activity, etc.) for use by the analytics manager 230 in generating the new predictive models 231, according to one embodiment. The claim manager 151 provides a user experience display (e.g., inclusive of one or more user interfaces) that enables users to enter claims of fraudulent activity by, for example, responding to questions in a fraud claims submission interview, according to one embodiment.

The security system 212 uses the fraud investigation module 152 to identify additional user accounts that have potentially been affected by fraudulent activity, according to one embodiment. The fraud investigation module 152 uses fraud data 232 and/or user accounts associated with risk score data 223 that is indicative of potentially fraudulent activity, according to one embodiment. The fraud investigation module 152 identifies additional user accounts by searching one or more of the user characteristics data 216, the financial data 220, and the system access data 221 for user accounts that have characteristics in common with a user account that has been flagged, reported, or otherwise identified as being associated with potentially fraudulent activity, according to one embodiment.

By using one or more of the claim manager 151, the fraud investigation module 152, the risk score threshold manager 153, and the authentication module 154 in the security system 212, the security system 212 provides faster responses to reports of fraudulent activity, proactively investigations additional user accounts for potential fraud, improves the fraud detection performance of the security system 212, and improves user verification services, according to one embodiment.

The service provider computing environment 210 includes a decision engine 233 that is used to host services to various applications and systems within the service provider computing environment 210, according to one embodiment. The service provider computing environment 210 uses the decision engine 233 to host the security system 212 to provide security services to a second service provider system 234 and to a third service provider system 235, according to one embodiment. The second service provider system 234 is a personal finance management system (e.g., Mint®), and the third service provider system 235 is a business finance management system (e.g., QuickBooks Online®), according to one embodiment.

In one embodiment, the decision engine 233 provides security services with the security system 212 to systems that are outside of the service provider computing environment 210 (e.g., to third party systems) by, for example, receiving system access data and by providing risk score data, to facilitate determination of fraudulent activity by the outside systems.

The service provider computing environment 210 includes memory 236 and processors 237 for providing methods and systems for identifying and addressing potential stolen identity refund fraud r activities/fraud in the tax return preparation system 211, according to one embodiment. The memory 236 stores data representing computer instructions for the tax return preparation system 211 and/or the security system 212, according to one embodiment.

### Process

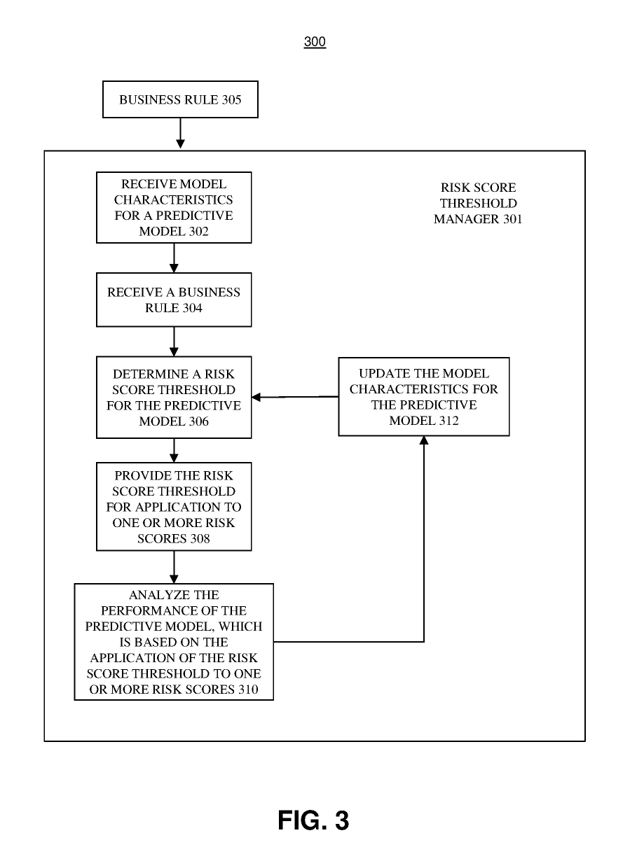

FIG. 3 illustrates an example flow diagram of a process 300 for improving risk score thresholds in a tax return preparation system to improve the performance of one or more predictive models in identifying potentially fraudulent activity, according to one embodiment. The process 300 includes operations by a risk score threshold manager 301, according to one embodiment. The risk score threshold manager 301 is the risk score threshold manager 153 (shown in FIGS. 1 and 2), according to one embodiment.

At operation 302, the risk score threshold manager 301 receives model characteristics for a predictive model, according to one embodiment. The predictive model is trained to generate risk score data that represents one or more risk scores for one or more risk categories in a tax return preparation system, according to one embodiment. The model characteristics include receiver operating characteristics of the predictive model, according to one embodiment. The receiver operating characteristics represent the performance of the predictive model based on the inputs provided to the predictive model and based on the output generated by the predictive model, according to one embodiment. The performance is measured in terms of a false-positive rate against a true-positive rate, according to one embodiment. Operation 302 proceeds to operation 304, according to one embodiment.

At operation 304, the risk score threshold manager 301 receives a business rule 305, according to one embodiment. The business rule 305 represents one or more criteria that are determined by, for example, the service provider that provides and/or manages the tax return preparation system, according to one embodiment. Examples of business rules include, but are not limited to, limits on false-positive rates, limits on true-positive rates, and the like, according to one embodiment. For example, the business rule can state that the predictive models should operate with a false-negative rate of less than 0.05 (i.e., 5%), according to one embodiment. Operation 304 proceeds to operation 306, according to one embodiment.

At operation 306, the risk score threshold manager 301 determines a risk score threshold for the predictive model, according to one embodiment. The risk score threshold manager 301 determines the risk score threshold for the predictive model at least partially based on the performance of the predictive model and at least partially based on the business rule 305, according to one embodiment. Operation 306 proceeds to operation 308, according to one embodiment.

At operation 308, the risk score threshold manager 301 provides the risk score threshold for application to one or more risk scores, according to one embodiment. Operation 308 proceeds to operation 310, according to one embodiment.

At operation 310, the risk score threshold manager 301 analyzes the performance of the predictive model, which is based on the application of the risk score threshold to one or more risk scores, according to one embodiment. Operation 310 proceeds to operation 312, according to one embodiment.

At operation 312, the risk score threshold manager 301 updates the model characteristics for the predictive model, according to one embodiment. In one embodiment, updating the model characteristics for the predictive model includes receiving an updated version of the model characteristics for the predictive model, according to one embodiment. Operation 312 proceeds back to operation 306 to enable the risk score threshold manager 301 to reevaluate and re-determine the risk score threshold for the one or more risk scores, according to one embodiment. The process 300 is configured to repeatedly evaluate and adjust the risk score thresholds to cause the operations of the predictive model to satisfy the business rule 305, according to one embodiment.

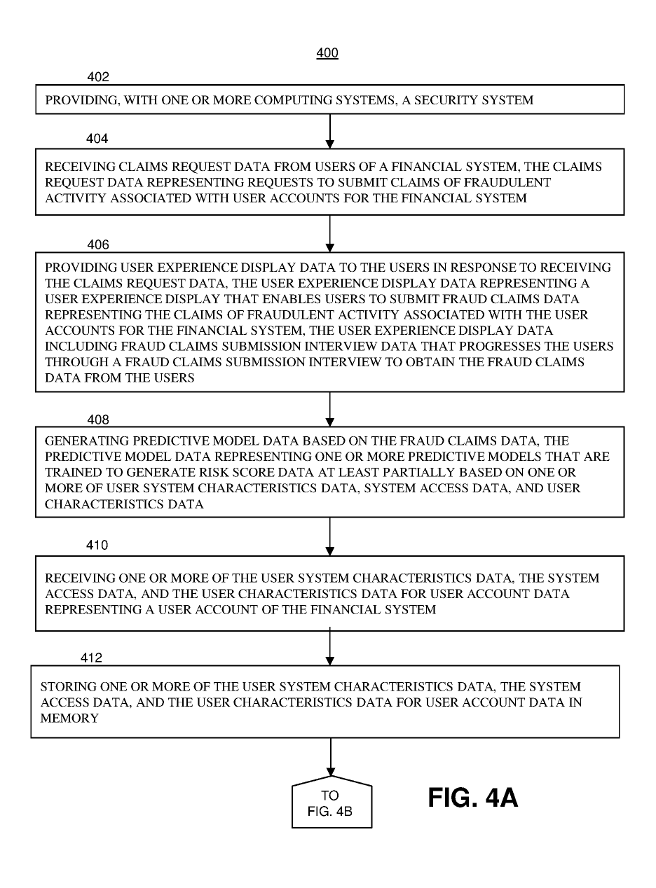

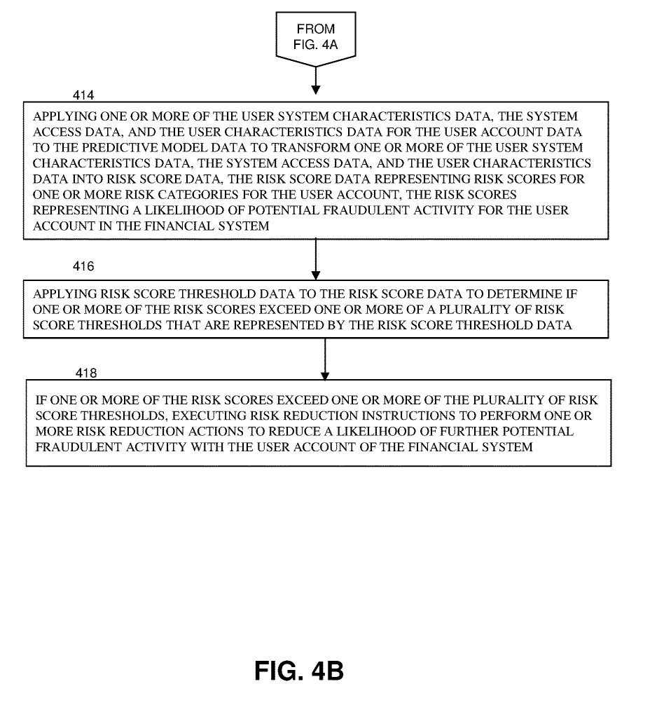

FIG. 4 illustrates an example flow diagram of a process 400 for facilitating the identification and reduction of potentially fraudulent activity in a financial system, according to one embodiment.

At operation 402, the process includes providing, with one or more computing systems, a security system, according to one embodiment. The security system or the features/functionality of the security system are integrated into the financial system, according to one embodiment. The financial system is a tax return preparation system, according to one embodiment. Operation 402 proceeds to operation 404, according to one embodiment.

At operation 404, the process includes receiving claims request data from users of a financial system, the claims request data representing requests to submit claims of fraudulent activity associated with user accounts for the financial system, according to one embodiment. The claims request data is received by the security system when a user selects a user interface element (e.g., a selection button) that notifies the financial system or the security system that the user would like to submit a claim of fraudulent activity, according to one embodiment. The security system receives the claims request data from the financial system, according to one embodiment. Operation 404 proceeds to operation 406, according to one embodiment.

At operation 406, the process includes providing user experience display data to the users in response to receiving the claims request data, the user experience display data representing a user experience display that enables users to submit fraud claims data representing the claims of fraudulent activity associated with the user accounts for the financial system, the user experience display data including fraud claims submission interview data that progresses the users through a fraud claims submission interview to obtain the fraud claims data from the users, according to one embodiment. The fraud claims submission interview includes one or more user interface pages that are represented by the user experience display data, according to one embodiment. The one or more user interface pages present information, questions, text boxes, and other user interface elements that enable users to submit the details of their claims of fraudulent activity for the user accounts, according to one embodiment. Operation 406 proceeds to operation 408, according to one embodiment.

At operation 408, the process includes generating predictive model data based on the fraud claims data, the predictive model data representing one or more predictive models that are trained to generate risk score data at least partially based on one or more of user system characteristics data, system access data, and user characteristics data, according to one embodiment. Operation 408 proceeds to operation 410, according to one embodiment.

At operation 410, the process includes receiving one or more of the user system characteristics data, the system access data, and the user characteristics data for user account data representing a user account of the financial system, according to one embodiment. In one embodiment, the security system receives one or more of the user system characteristics data, the system access data, and the user characteristics data from a database that is accessible by both the security system and the financial system, according to one embodiment. The financial system populate the database with the user system characteristics data, the system access data, and the user characteristics data, according to one embodiment. Operation 410 proceeds to operation 412, according to one embodiment.

At operation 412, the process includes storing one or more of the user system characteristics data, the system access data, and the user characteristics data for user account data in memory, according to one embodiment. In one embodiment, the security system stores the user system characteristics data, the system access data, and/or the user characteristics data in volatile memory (e.g., random access memory) to support further processing and transformation of the data into risk scores and into risk reduction actions by the security system, according to one embodiment. Operation 412 proceeds to operation 414, according to one embodiment.

At operation 414, the process includes applying one or more of the user system characteristics data, the system access data, and the user characteristics data for the user account data to the predictive model data to transform one or more of the user system characteristics data, the system access data, and the user characteristics data into risk score data, the risk score data representing risk scores for one or more risk categories for the user account, the risk scores representing a likelihood of potential fraudulent activity for the user account in the financial system, according to one embodiment. Operation 414 proceeds to operation 416, according to one embodiment.

At operation 416, the process includes applying risk score threshold data to the risk score data to determine if one or more of the risk scores exceed one or more of a plurality of risk score thresholds that are represented by the risk score threshold data, according to one embodiment. Operation 416 proceeds to operation 418, according to one embodiment.

At operation 418, the process includes, if one or more of the risk scores exceed one or more of the plurality of risk score thresholds, executing risk reduction instructions to perform one or more risk reduction actions to reduce a likelihood of further potential fraudulent activity with the user account of the financial system, according to one embodiment.

In one embodiment, the security system uses a claim manager to interface with users of the financial system to acquire the claims request data, according to one embodiment. The acquisition of the claims request data directly from users enables the security system to bypass interactions with customer support representatives, which can inject time delays into the process of performing risk reduction actions to reduce the likelihood of further potential fraudulent activity with the flag/reported user accounts. In other words, upon receipt of claims request data, the security system can be configured to immediately perform one or more risk reduction actions for the flag/reported user accounts, according to one embodiment. Also, customer support representatives may hold working hours that prevent the immediate processing of fraudulent claims, which embodiments of the present disclosure result, according to one embodiment. In one embodiment, an additional benefit of the present disclosure is that additional versions of predictive models can be generated/trained more rapidly than if the reported claims of fraud are first processed by customer support representatives.

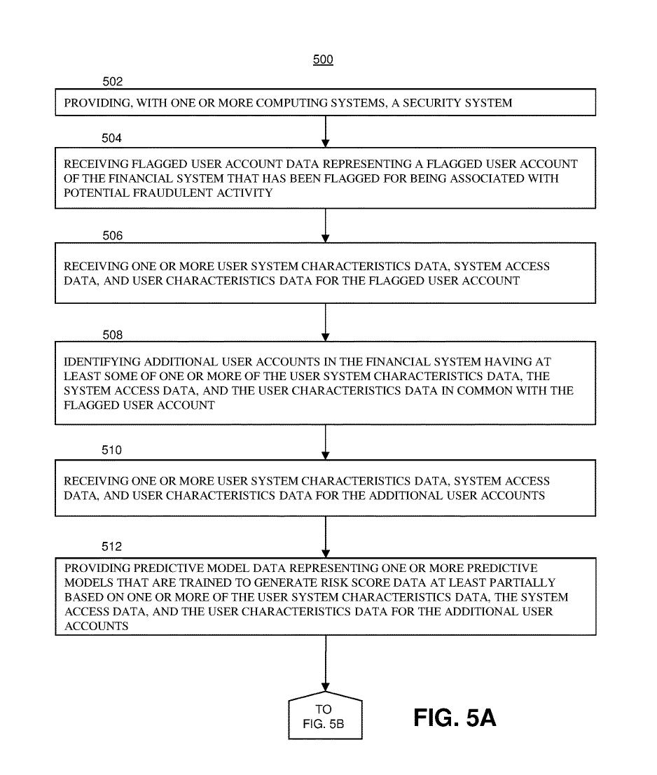

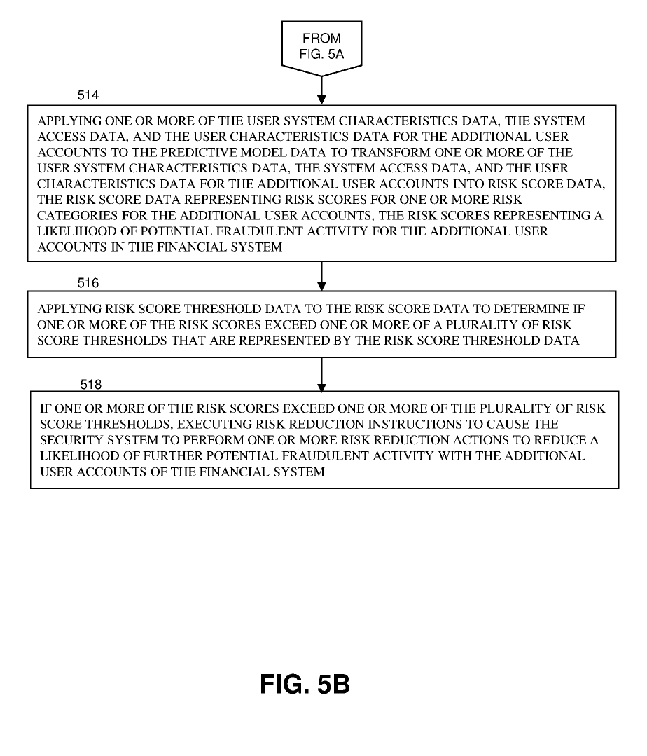

FIGS. 5A and 5B illustrate an example flow diagram of a process 500 for facilitating the identification and reduction of potentially fraudulent activity in a financial system, according to one embodiment.

At operation 502, the process includes providing, with one or more computing systems, a security system, according to one embodiment. The security system or the features/functionality of the security system are integrated into the financial system, according to one embodiment. The financial system is a tax return preparation system, according to one embodiment. Operation 502 proceeds to operation 504, according to one embodiment.

At operation 504, the process includes receiving flagged user account data representing a flagged user account of the financial system that has been flagged for being associated with potential fraudulent activity, according to one embodiment. Operation 504 proceeds to operation 506, according to one embodiment.

At operation 506, the process includes receiving one or more user system characteristics data, system access data, and user characteristics data for the flagged user account, according to one embodiment. Operation 506 proceeds to operation 508, according to one embodiment.

At operation 508, the process includes identifying additional user accounts in the financial system having at least some of one or more of the user system characteristics data, the system access data, and the user characteristics data in common with the flagged user account, according to one embodiment. In other words, the security system identifies the characteristics of the flagged user account, searches through the characteristics of the other user accounts for the financial system, and identifies additional user accounts for risk analysis based on whether or not the additional user accounts have one or more characteristics in common with the flagged user account, according to one embodiment. By identifying additional user accounts in this manner, additional user accounts that may not have been initially flagged as being associated with potentially fraudulent activity are more closely scrutinized/investigated/reviewed for potentially file activity, in order to protect users of the financial system, according to one embodiment. Accordingly, the methods and systems disclosed herein proactively seek and/or investigate user accounts to reduce the likelihood of future potential fraudulent activity, according to one embodiment. Operation 508 proceeds to operation 510, according to one embodiment.

At operation 510, the process includes receiving one or more user system characteristics data, system access data, and user characteristics data for the additional user accounts, according to one embodiment. Operation 510 proceeds to operation 512, according to one embodiment.

At operation 512, the process includes providing predictive model data representing one or more predictive models that are trained to generate risk score data at least partially based on one or more of the user system characteristics data, the system access data, and the user characteristics data for the additional user accounts, according to one embodiment. Operation 512 proceeds to operation 514, according to one embodiment.

At operation 514, the process includes applying one or more of the user system characteristics data, the system access data, and the user characteristics data for the additional user accounts to the predictive model data to transform one or more of the user system characteristics data, the system access data, and the user characteristics data for the additional user accounts into risk score data, the risk score data representing risk scores for one or more risk categories for the additional user accounts, the risk scores representing a likelihood of potential fraudulent activity for the additional user accounts in the financial system, according to one embodiment. Operation 514 proceeds to operation 516, according to one embodiment.

At operation 516, the process includes applying risk score threshold data to the risk score data to determine if one or more of the risk scores exceed one or more of a plurality of risk score thresholds that are represented by the risk score threshold data, according to one embodiment. Operation 516 proceeds to operation 518, according to one embodiment.

At operation 518, the process includes, if one or more of the risk scores exceed one or more of the plurality of risk score thresholds, executing risk reduction instructions to cause the security system to perform one or more risk reduction actions to reduce a likelihood of further potential fraudulent activity with the additional user accounts of the financial system, according to one embodiment.

As noted above, the specific illustrative examples discussed above are but illustrative examples of implementations of embodiments of the method or process for facilitating identification and reduction of potentially fraudulent activity in a financial system. Those of skill in the art will readily recognize that other implementations and embodiments are possible. Therefore the discussion above should not be construed as a limitation on the claims provided below.

By facilitating identification and reduction of potentially fraudulent activity (e.g., ATO, SIRF, etc.) in a financial system, implementation of embodiments of the present disclosure allows for significant improvement to the fields of data security, financial systems security, electronic tax return preparation, data collection, and data processing, according to one embodiment. As illustrative examples, by facilitating identification and reduction of potentially fraudulent activity, fraudsters can be deterred from criminal activity, financial system providers may retain/build trusting relationships with customers, customers may be spared financial losses, criminally funded activities may be decreased due to less or lack of funding, and tax refunds may be delivered to authorized recipients faster (due to less likelihood of unauthorized recipients). As another example, by identifying and implementing risk reducing actions, tax filer complaints to the Internal Revenue Service (“IRS”) and to financial system service providers may be reduced. As yet another example, some of the disclosed techniques facilitate real-time risk analysis, which enables the security system to reduce delays in executing preventative and/or remedial measures against would-be fraudsters. As a result, embodiments of the present disclosure allow for reduced communication channel bandwidth utilization and faster communications connections. Consequently, computing and communication systems implementing and/or providing the embodiments of the present disclosure are transformed into faster and more operationally efficient devices and systems.

In addition to improving overall computing performance, by facilitating identification and reduction of potentially fraudulent activity in a financial system, implementation of embodiments of the present disclosure represent a significant improvement to the field of providing an efficient user experience and, in particular, efficient use of human and non-human resources. As one illustrative example, by identifying and addressing fraudulent activity in user accounts, users can devote less time and energy to resolving issues associated with account abuse. Additionally, by identifying and addressing potential stolen identity refund fraud activity in a financial system, the financial system maintains, improves, and/or increases the likelihood that a customer will remain a paying customer and advertise the received services to the customer's peers, according to one embodiment. Consequently, using embodiments of the present disclosure, the user's experience is less burdensome and time consuming and allows the user to dedicate more of his or her time to other activities or endeavors.

In accordance with an embodiment, a computing system implemented method facilitates identification and prevention of potential fraudulent activity in a financial system. The method includes providing, with one or more computing systems, a security system, according to one embodiment. The method includes providing predictive model data representing one or more predictive models that are trained to generate risk score data at least partially based on one or more of user system characteristics data, system access data, and user characteristics data for user accounts of a financial system, according to one embodiment. The method includes receiving one or more of the user system characteristics data, the system access data, and the user characteristics data for user account data representing the user accounts, according to one embodiment. The method includes applying one or more of the user system characteristics data, the system access data, and the user characteristics data for the user account data to the predictive model data to transform one or more of the user system characteristics data, the system access data, and the user characteristics data into risk score data, the risk score data representing risk scores for one or more risk categories for the user accounts, the risk scores representing a likelihood of potential fraudulent activity for the user accounts in the financial system, according to one embodiment. The method includes applying risk score threshold data to the risk score data to determine if one or more of the risk scores exceed one or more of a plurality of risk score thresholds that are represented by the risk score threshold data, according to one embodiment. The method includes evaluating false-positive rates and false-negative rates for the one or more predictive models to determine performance data representing performance of the one or more predictive models, according to one embodiment. The method includes adjusting the plurality of risk score thresholds at least partially based on the performance data to decrease at least one of the false-positive rates and the false-negative rates, according to one embodiment. The method includes, if one or more of the risk scores exceed one or more of the plurality of risk score thresholds, executing risk reduction instructions to perform one or more risk reduction actions to reduce a likelihood of further potential fraudulent activity with the user account of the financial system, according to one embodiment.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGS., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for facilitating identification and prevention of potential fraudulent activity in a financial system, comprising:
providing, with one or more computing systems, a security system;
receiving claims request data from users of a financial system, the claims request data representing requests to submit claims of fraudulent activity associated with user accounts for the financial system;
providing user experience display data to the users in response to receiving the claims request data, the user experience display data representing a user experience display that enables users to submit fraud claims data representing the claims of fraudulent activity associated with the user accounts for the financial system, the user experience display data including fraud claims submission interview data that progresses the users through a fraud claims submission interview to obtain the fraud claims data from the users;
generating predictive model data based on the fraud claims data, the predictive model data representing one or more predictive models that are trained to generate risk score data at least partially based on one or more of user system characteristics data, system access data, and user characteristics data;
receiving one or more of the user system characteristics data, the system access data, and the user characteristics data for user account data representing a user account of the financial system;
storing one or more of the user system characteristics data, the system access data, and the user characteristics data for user account data in memory;
applying one or more of the user system characteristics data, the system access data, and the user characteristics data for the user account data to the predictive model data to transform one or more of the user system characteristics data, the system access data, and the user characteristics data into risk score data, the risk score data representing risk scores for one or more risk categories for the user account, the risk scores representing a likelihood of potential fraudulent activity for the user account in the financial system;
applying risk score threshold data to the risk score data to determine if one or more of the risk scores exceed one or more of a plurality of risk score thresholds that are represented by the risk score threshold data; and
if one or more of the risk scores exceed one or more of the plurality of risk score thresholds, executing risk reduction instructions to perform one or more risk reduction actions to reduce a likelihood of further potential fraudulent activity with the user account of the financial system.

2. The computing system implemented method of claim 1, wherein the claims request data is generated in response to the users selecting a user interface element provided to enable reporting suspicious user account activity.

3. The computing system implemented method of claim 1, wherein receiving the claims request data includes receiving the claims request data by the security system configured to identify and address potential fraudulent activity in the financial system, wherein the security system is part of the financial system.

4. The computing system implemented method of claim 1, wherein the claims of fraudulent activity associated with the user accounts for the financial system include one or more of identity information of owners of the user accounts, usernames for the user accounts, user account identifiers for the user accounts, and descriptions of fraudulent activities associated with the user accounts.

5. The computing system implemented method of claim 4, wherein the identity information of owners of the user accounts includes one or more of:
a date of birth or a date of creation of the owner of the identity information;
an address of the owner of the identity information;
a name of the owner; and
a government identification number of the owner.

6. The computing system implemented method of claim 1, wherein the fraud claims submission interview includes one or more questions and user interface elements that are configured to assist the users in describing the claims of fraudulent activity.

7. The computing system implemented method of claim 1, wherein the one or more risk categories are selected from a group of risk categories, consisting of:
user system characteristics;
tax return filing characteristics;
IP address characteristics;
age of user account; and
user account characteristics.

8. The computing system implemented method of claim 7, wherein the user system characteristics include at least:
an operating system used by a user system to access a user account in the financial system;
a hardware identifier of a user system used to access a user account in the financial system; and
a web browser used by a user system to access a user account in the financial system.

9. The computing system implemented method of claim 7, wherein the tax return filing characteristics include one or more of:
a filing date of a tax return;
a preparation duration of a tax return;
a tax refund amount for a tax return;
a relative filing time within a tax season of a tax return;
a difference between a present year's tax refund amount and a previous year's tax refund amount for an owner of identity information; and
a financial institution account for receipt of a tax refund for a tax return.

10. The computing system implemented method of claim 7, wherein the IP address characteristics include one or more of:
a fixed or dynamic characteristic of an IP address;
whether an IP address is associated with a corporation or residence;
whether an IP address is associated with cloud-based service;
a continent with which an IP address is associated;
a country with which an IP address is associated;
a state with which an IP address is associated; and
a change in any prior IP address characteristics for a user system used to access the user account.

11. The computing system implemented method of claim 7, wherein the user account characteristics include one or more of:
a user name for the user account;
a password for the user account;
a mobile telephone number associated with the account;
login history for the user account;
a state from which the user account is historically accessed;
a region of a country from which the user account is historically accessed; and
a country from which the user account is historically accessed.

12. The computing system implemented method of claim 1, further comprising:
transmitting the system access data to a third party server to generate the user system characteristics data of one or more user computing systems used to access the user accounts; and
wherein applying the system access data to the predictive model data includes applying the user system characteristics data to the predictive model data to transform the system access data into the risk score data.

13. The computing system implemented method of claim 12, wherein the user system characteristics data is at least partially based on clickstream data from the one or more computing systems that accessed the user account.

14. The computing system implemented method of claim 1, further comprising:
generating receiver operating characteristics data representing receiver operating characteristics of the one or more predictive models represented by the predictive model data; and
determining the plurality of risk score thresholds at least partially based on the receiver operating characteristics of the one or more predictive models to estimate quantities of false-negative errors for the plurality of risk score thresholds.

15. The computing system implemented method of claim 1, wherein the predictive model transforms the system access data into the risk score data at least partially based on year-to-year changes of financial characteristics of an owner of identity information associated with the user account.

16. The computing system implemented method of claim 1, wherein the system access data is selected from a group of system access data consisting of:
data representing an age of a user account;
data representing features or characteristics associated with an interaction between a client system and the financial system;
data representing a web browser of a user computing system;
data representing an operating system of a user computing system;
data representing a media access control address of the user computing system;
data representing user credentials used to access the user account;
data representing a user account;
data representing a user account identifier;
data representing interaction behavior between a user computing system and the financial system;
data representing characteristics of an access session for the user account;
data representing an IP address of a user computing system; and
data representing characteristics of an IP address of the user computing system.

17. The computing system implemented method of claim 1, wherein the one or more risk reduction actions includes alerting the financial system, from the security system, of the likelihood of further potential fraudulent activity with the user account of the financial system, to enable the financial system to increase security for the user account.

18. The computing system implemented method of claim 1, wherein the one or more risk reduction actions are selected from a group of risk reduction actions, consisting of:
preventing a user from taking an action within the user account of the financial system;
preventing a user from logging into the user account;
increasing authentication requirements to access the user account in the financial system;
terminating an access session for the user account;
notifying an owner of identity information of the potential fraudulent activity via email, text message, and/or a telephone call;
requiring additional factors in a multifactor authentication process prior to providing access the user account;
removing one or more multifactor authentication options to increase a difficulty of authentication for the user account; and
temporarily suspending a tax return filing from transmission to a state and/or a federal revenue service.

19. The computing system implemented method of claim 1, wherein generating the predictive model data includes applying a predictive model training operation to the fraud claims data, the predictive model training operation being selected from a group of predictive model training operations, consisting of:
regression;
logistic regression;
decision trees;
artificial neural networks;
support vector machines;
linear regression;
nearest neighbor methods;
distance based methods;
naive Bayes;
linear discriminant analysis; and
k-nearest neighbor algorithm.

20. The computing system implemented method of claim 1, wherein the predictive model data generates the risk score data at least partially based on user characteristics data of an owner of identity information associated with the user account, the user characteristics data being selected from a group of user characteristics data, consisting of:
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

21. A computing system implemented method for facilitating identification and prevention of potential fraudulent activity in a financial system, comprising:
providing, with one or more computing systems, a security system;
receiving flagged user account data representing a flagged user account of the financial system that has been flagged for being associated with potential fraudulent activity;
receiving one or more user system characteristics data, system access data, and user characteristics data for the flagged user account;
identifying additional user accounts in the financial system having at least some of one or more of the user system characteristics data, the system access data, and the user characteristics data in common with the flagged user account;
receiving one or more user system characteristics data, system access data, and user characteristics data for the additional user accounts;
providing predictive model data representing one or more predictive models that are trained to generate risk score data at least partially based on one or more of the user system characteristics data, the system access data, and the user characteristics data for the additional user accounts;
applying one or more of the user system characteristics data, the system access data, and the user characteristics data for the additional user accounts to the predictive model data to transform one or more of the user system characteristics data, the system access data, and the user characteristics data for the additional user accounts into risk score data, the risk score data representing risk scores for one or more risk categories for the additional user accounts, the risk scores representing a likelihood of potential fraudulent activity for the additional user accounts in the financial system;
applying risk score threshold data to the risk score data to determine if one or more of the risk scores exceed one or more of a plurality of risk score thresholds that are represented by the risk score threshold data; and
if one or more of the risk scores exceed one or more of the plurality of risk score thresholds, executing risk reduction instructions to cause the security system to perform one or more risk reduction actions to reduce a likelihood of further potential fraudulent activity with the additional user accounts of the financial system.

22. The computing system implemented method of claim 21, wherein receiving user account data includes receiving identification information data of an owner of a user account, the method further comprising identifying the additional user accounts at least partially based on the identification information data of the owner, wherein the owner is a person or a business entity.

23. The computing system implemented method of claim 21, wherein the potential fraudulent activity includes account takeover or stolen identity refund fraud activity.

24. The computing system implemented method of claim 23, wherein stolen identity refund fraud activity includes:
obtaining identity information of an owner of the identity information without permission from the owner of the identity information;
creating a fraudulent user account in the financial system with the identity information, the identity information being associated with the fraudulent user account; and
preparing at least part of a tax return in the financial system with the fraudulent user account and with the identity information of the owner of the identity information.

25. The computing system implemented method of claim 21, wherein identifying additional user accounts in the financial system includes searching a database that is populated with user accounts data by the financial system for user accounts having at least a predetermined number of characteristics that are similar to characteristics of the flagged user account.

26. The computing system implemented method of claim 21, wherein receiving the flagged user account data includes receiving the flagged user account data from a customer support representative for the financial system or from a user of the financial system.

27. The computing system implemented method of claim 21, further comprising:
providing the additional user accounts to a fraud investigation team to verify whether the additional user accounts are associated with the potential fraudulent activity.

28. The computing system implemented method of claim 21, wherein the one or more risk categories are selected from a group of risk categories, consisting of:
user system characteristics;
tax return filing characteristics;
IP address characteristics;
age of a user account; and
user account characteristics.

29. The computing system implemented method of claim 28, wherein the user system characteristics include at least:
an operating system used by a user system to access a user account in the financial system;
a hardware identifier of a user system used to access a user account in the financial system; and
a web browser used by a user system to access a user account in the financial system.

30. The computing system implemented method of claim 28, wherein the tax return filing characteristics include one or more of:
a filing date of a tax return;
a preparation duration of a tax return;
a tax refund amount for a tax return;
a relative filing time within a tax season of a tax return;
a difference between a present year's tax refund amount and a previous year's tax refund amount for an owner of identity information; and
a financial institution account for receipt of a tax refund for a tax return.

31. The computing system implemented method of claim 28, wherein the IP address characteristics include one or more of:
a fixed or dynamic characteristic of an IP address;
whether an IP address is associated with a corporation or residence;
whether an IP address is associated with cloud-based service;
a continent with which an IP address is associated;
a country with which an IP address is associated;
a state with which an IP address is associated; and
a change in any prior IP address characteristics for a user system used to access the additional user accounts.

32. The computing system implemented method of claim 28, wherein the user account characteristics include one or more of:
a user name for a user account;
a password for a user account;
a mobile telephone number associated with a user account;
login history for a user account;
a state from which a user account is historically accessed;
a region of a country from which a user account is historically accessed; and
a country from which a user account is historically accessed.

33. The computing system implemented method of claim 21, further comprising:
receiving fraudulent activity data representing fraudulent use of multiple user accounts of the financial system; and
training the predictive model data at least partially based on the fraudulent activity data.

34. The computing system implemented method of claim 33, wherein receiving fraudulent activity data includes receiving the fraudulent activity data from a customer support organization that receives complaints from customers of the financial system.

35. The computing system implemented method of claim 34, wherein fraudulent use of multiple user accounts of the financial system includes fraudulent creation and/or fraudulent access of the multiple user accounts.

36. The computing system implemented method of claim 21, wherein the system access data is selected from a group of system access data consisting of:
data representing an age of a user account;
data representing features or characteristics associated with an interaction between a client system and the financial system;
data representing a web browser of a user computing system;
data representing an operating system of a user computing system;
data representing a media access control address of a user computing system;
data representing user credentials used to access a user account;
data representing a user account;
data representing a user account identifier;
data representing interaction behavior between a user computing system and the financial system;
data representing characteristics of an access session for a user account;
data representing an IP address of a user computing system; and
data representing characteristics of an IP address of the user computing system.

37. The computing system implemented method of claim 21, wherein the one or more risk reduction actions includes alerting the financial system of the likelihood of further potential fraudulent activity with the additional user accounts of the financial system, to enable the financial system to increase security for the additional user accounts.

38. The computing system implemented method of claim 21, wherein the one or more risk reduction actions are selected from a group of risk reduction actions, consisting of:
preventing a user from taking an action within the additional user accounts of the financial system;
preventing a user from logging into the additional user accounts;
increasing authentication requirements to access the additional user accounts in the financial system;
terminating an access session for the additional user accounts;
notifying an owner of identity information of the potential fraudulent activity via email, text message, and/or a telephone call;
requiring additional factors in a multifactor authentication process prior to providing access the additional user accounts;
removing one or more multifactor authentication options to increase a difficulty of authentication for the additional user accounts; and
temporarily suspending a tax return filing from transmission to a state and/or federal revenue service.

39. The computing system implemented method of claim 21, further comprising:
generating the predictive model data by applying a predictive model training operation to fraudulent activity data representing fraudulent use of multiple user accounts of the financial system, the predictive model training operation being selected from a group of predictive model training operations, consisting of:
regression;
logistic regression;
decision trees;
artificial neural networks;
support vector machines;
linear regression;
nearest neighbor methods;
distance based methods;
naive Bayes;
linear discriminant analysis; and
k-nearest neighbor algorithm.

40. The computing system implemented method of claim 21, wherein the predictive model data generates the risk score data at least partially based on user characteristics data of an owner of identity information associated with the additional user accounts, the user characteristics data being selected from a group of user characteristics data, consisting of:
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

41. A computing system implemented method for facilitating identification and prevention of potential fraudulent activity in a financial system, comprising:
providing, with one or more computing systems, a security system;
providing predictive model data representing one or more predictive models that are trained to generate risk score data at least partially based on one or more of user system characteristics data, system access data, and user characteristics data for user accounts of a financial system;
receiving one or more of the user system characteristics data, the system access data, and the user characteristics data for user account data representing the user accounts;
applying one or more of the user system characteristics data, the system access data, and the user characteristics data for the user account data to the predictive model data to transform one or more of the user system characteristics data, the system access data, and the user characteristics data into risk score data, the risk score data representing risk scores for one or more risk categories for the user accounts, the risk scores representing a likelihood of potential fraudulent activity for the user accounts in the financial system;
applying risk score threshold data to the risk score data to determine if one or more of the risk scores exceed one or more of a plurality of risk score thresholds that are represented by the risk score threshold data;
evaluating false-positive rates and false-negative rates for the one or more predictive models to determine performance data representing performance of the one or more predictive models;
adjusting the plurality of risk score thresholds at least partially based on the performance data to decrease at least one of the false-positive rates and the false-negative rates; and
if one or more of the risk scores exceed one or more of the plurality of risk score thresholds, executing risk reduction instructions to perform one or more risk reduction actions to reduce a likelihood of further potential fraudulent activity with the user account of the financial system.

42. The computing system implemented method of claim 41, wherein evaluating false-positive rates and false-negative rates includes electronically communicating with users associated with user accounts that result in one or more of the risk scores that exceed one or more of the plurality of risk score thresholds.

43. The computing system implemented method of claim 42, wherein electronically communicating with users includes one or more of:
transmitting a text message to the users;
transmitting an email message to the users;
providing a telephone-based survey; and
providing web-based link to a survey.

44. The computing system implemented method of claim 41, wherein adjusting the plurality of risk score thresholds includes increasing and/or decreasing one or more of the plurality of risk score thresholds.

45. The computing system implemented method of claim 41, further comprising:
periodically and repeatedly:
evaluating the false-positive rates and the false-negative rates; and
adjusting the plurality of risk score thresholds.

46. The computing system implemented method of claim 41, wherein the potential fraudulent activity includes account takeover or stolen identity refund fraud activity.

47. The computing system implemented method of claim 46, wherein stolen identity refund fraud activity includes:
obtaining identity information of an owner of the identity information without permission from the owner of the identity information;
creating a fraudulent user account in the financial system with the identity information, the identity information being associated with the fraudulent user account; and
preparing at least part of a tax return in the financial system with the fraudulent user account and with the identity information of the owner of the identity information.

48. The computing system implemented method of claim 41, wherein the one or more risk categories are selected from a group of risk categories, consisting of:
user system characteristics;
tax return filing characteristics;
IP address characteristics;
age of a user account; and
user account characteristics.

49. The computing system implemented method of claim 48, wherein the user system characteristics include at least:
an operating system used by a user system to access a user account in the financial system;
a hardware identifier of a user system used to access a user account in the financial system; and
a web browser used by a user system to access a user account in the financial system.

50. The computing system implemented method of claim 48, wherein the tax return filing characteristics include one or more of:
a filing date of a tax return;
a preparation duration of a tax return;
a tax refund amount for a tax return;
a relative filing time within a tax season of a tax return;
a difference between a present year's tax refund amount and a previous year's tax refund amount for an owner of identity information; and
a financial institution account for receipt of a tax refund for a tax return.

51. The computing system implemented method of claim 48, wherein the IP address characteristics include one or more of:
a fixed or dynamic characteristic of an IP address;
whether an IP address is associated with a corporation or residence;
whether an IP address is associated with cloud-based service;
a continent with which an IP address is associated;
a country with which an IP address is associated;
a state with which an IP address is associated; and
a change in any prior IP address characteristics for a user system used to access the user accounts.

52. The computing system implemented method of claim 48, wherein the user account characteristics include one or more of:
a user name for a user account;
a password for a user account;
a mobile telephone number associated with a user account;
login history for a user account;
a state from which a user account is historically accessed;
a region of a country from which a user account is historically accessed; and
a country from which a user account is historically accessed.

53. The computing system implemented method of claim 41, wherein the system access data is selected from a group of system access data consisting of:
data representing an age of a user account;
data representing features or characteristics associated with an interaction between a client system and the financial system;
data representing a web browser of a user computing system;
data representing an operating system of a user computing system;
data representing a media access control address of a user computing system;
data representing user credentials used to access a user account;
data representing a user account;
data representing a user account identifier;
data representing interaction behavior between a user computing system and the financial system;
data representing a duration of an access session for a user account;
data representing characteristics of an access session for a user account;
data representing an IP address of a user computing system; and
data representing characteristics of an IP address of the user computing system.

54. The computing system implemented method of claim 41, wherein the one or more risk reduction actions includes alerting the financial system of the likelihood of further potential fraudulent activity with the user accounts of the financial system, to enable the financial system to increase security for the user accounts.

55. The computing system implemented method of claim 41, wherein the one or more risk reduction actions are selected from a group of risk reduction actions, consisting of:
preventing a user from taking an action within the user accounts of the financial system;
preventing a user from logging into the user accounts;
increasing authentication requirements to access the user accounts in the financial system;
terminating an access session for the user accounts;
notifying an owner of identity information of the potential fraudulent activity via email, text message, and/or a telephone call;
requiring factors in a multifactor authentication process prior to providing access the user accounts;
removing one or more multifactor authentication options to increase a difficulty of authentication for the user accounts; and
temporarily suspending a tax return filing from transmission to a state and/or federal revenue service.

56. The computing system implemented method of claim 41, wherein the predictive model data generates the risk score data at least partially based on user characteristics data of an owner of identity information associated with the user accounts, the user characteristics data being selected from a group of user characteristics data, consisting of:
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.
